(19) United States
(12) Patent Application Publication
(10) Pub. No.: US 2007/0139781 A1
(43) Pub. Date: Jun. 21, 2007

(54) Optical film, and polarizing plate, image display device and liquid crystal display device including the same

(75) Inventors: Katsumi Inoue, Minami-Ashigara-shi (JP); Tetsuya Asakura, Minami-Ashigara-shi (JP)

Correspondence Address: BUCHANAN, INGERSOLL & ROONEY PC, POST OFFICE BOX 1404, ALEXANDRIA, VA, 22313-1404, US

(73) Assignee: FUJIFILM Corporation, Tokyo (JP)

(21) Appl. No.: 11/639,293

(22) Filed: Dec. 15, 2006

(30) Foreign Application Priority Data
Dec. 15, 2005 (JP) 2005-362054

(51) Int. Cl. G02B 5/02

(52) U.S. Cl. 359/599

(57) ABSTRACT

An optical film comprising a transparent support and a light scattering layer, wherein the light scattering layer contains at least two translucent particles including first translucent particles and second translucent particles in a matrix of the light scattering layer, the first translucent particles have an average particle size of larger than 5 μm and not more than 15 μm, and the second translucent particles have an average particle size of 0.5 μm or more and not more than 5 μm, in which a difference between a refractive index of the second translucent particles and a refractive index of the matrix is 0.04 or more, and the light scattering layer has a thickness of from 8 to 30 μm.

### FIELD OF THE INVENTION

The present invention relates to an optical film, a polarizing plate and a display device including the same.

### BACKGROUND OF THE INVENTION

In recent years, in a liquid crystal display device (LCD), an increase of the screen size is advancing, and liquid crystal display devices having an optical film, for example, an antireflection film and a light diffusing sheet, disposed therein are increasing. In various image display devices, for example, a liquid crystal display device (LCD), a plasma display panel (PDP), an electroluminescence display (ELD), and a cathode ray tube display device (CRT), for the purpose of preventing reflection of external light or a lowering of contrast due to reflection of an image, the antireflection film is disposed on a surface of a display. Also, the light diffusing sheet is used for backlight of a liquid crystal display device.

An antireflection film which is one kind of optical films is in general prepared by stacking a light diffusing layer or a high refractive index layer and a low refractive index layer, etc. on a transparent support. With respect to the placing method, in many cases, a transparent thin film made of a metal oxide is prepared by a chemical vapor deposition (CVD) method or a physical vapor deposition (PVD) method, in particular, a vacuum vapor deposition method or a sputtering method which is one kind of the physical vapor deposition method, or a coating method which is excellent in productivity (see JP-A-59-50401).

Since the antireflection film is used on an outermost surface of a display, it is required to have various film strengths, for example, scar resistance against fine scratches and film strength endurable against a pressure when written by writing implements.

In order to respond to these requirements, there have been employed a method of stacking a hard layer on the surface (see JP-A-2002-139602); a method of containing an organosilane compound in a coating composition (see JP-A-2003-222704); and a method of forming a hydrolyzate of an organosilane compound and/or a dehydration condensate thereof in advance by reaction using an acid catalyst or a metal chelate catalyst and containing it in a coating composition (see JP-A-2004-170901). However, these methods were not sufficient yet for the purpose of enhancing the hardness of a coating film.

The present inventor made extensive and intensive investigations. As a result, it has been found that according to a configuration in which a thickness of an optically functional layer, a particle size of resin particles to be contained and surface optical characteristics are set up within specified ranges, a necessary optical performance is stably obtained while having a high film hardness.

### SUMMARY OF THE INVENTION

An object of the invention is to provide an optical film which stably exhibits a necessary optical performance while having a strong film strength. Another object of the invention is to provide a polarizing plate or a display device including such an optical film.

According to the invention, the foregoing objects are achieved by providing an optical film, a polarizing plate and an image display device each having the following configuration having a strong film strength and preferred optical characteristics by thickening a thickness of a light scattering layer, using a large-sized resin particle for making it adaptive to this thickness and jointly using a small-sized particle having a specified refractive index for the purpose of obtaining preferred internal scattering properties.
(1) An optical film comprising a transparent support and a light scattering layer, wherein

the light scattering layer contains at least two kinds of translucent particles in a matrix of the layer, at least one kind of the translucent particles has an average particle size of larger than 5 μm and not more than 15 μm (particle A), and at least one kind thereof has an average particle size of 0.5 μm or more and not more than 5 μm (particle B) and a difference in refractive index from the matrix of 0.04 or more; and

the light scattering layer has a thickness of from 8 to 30 μm.
(2) The optical film as set forth above in (1), wherein a haze value as caused due to surface scattering is not more than 10%.
(3) The optical film as set forth above in claim 1 or 2, wherein a haze value as caused due to internal scattering is from 10 to 90%.
(4) The optical film as set forth above in any one of (1) to (3), wherein a haze value as caused due to internal scattering caused by the particle B is from 10 to 90%.
(5) The optical film as set forth above in any one of (1) to (4), wherein a difference between a refractive index of the particle A and a refractive index of the matrix is smaller than a difference in refractive index between the particle B and the matrix.
(6) The optical film as set forth above in any one of (1) to (5), wherein a difference between a refractive index of the particle A and a refractive index of the matrix is within 0.05.
(7) An optical film comprising the optical film as set forth above in any one of (1) to (6) and a layer with a lower refractive index than the light scattering layer.
(8) The optical film as set forth above in any one of (1) to (7), wherein an integrated reflectance is not more than 3.5%.
(9) A polarizing plate comprising a polarizing film and two protective films for protecting both surfaces of a front side and a back side of the polarizing film, wherein at least one of the protective films is the optical film as set forth above in any one of (1) to (8).
(10) An image display device having the optical film as set forth above in any one of (1) to (8) or the polarizing plate as set forth above in (9).
(11) A liquid crystal display device having the optical film as set forth above in any one of (1) to (8) or the polarizing plate as set forth above in (9).

The optical film of the invention stably exhibits a necessary optical performance while having a strong film strength. In addition, a display to which this optical film is applied is excellent in firmness of black color. Furthermore, a display device provided with the optical film of the invention and a display device provided with a polarizing plate including the optical film of the invention are less in reflection of external light or reflection of a background, extremely high in visibility, less in display unevenness, excellent in frontal contrast and contrast in an oblique direction and high in display grade.

### DETAILED DESCRIPTION OF THE INVENTION

The optical film of the invention has at least a light scattering layer on a transparent support. In the light scattering layer, translucent particles are dispersed in a matrix of the subject layer; the light scattering layer may be a light scattering layer having antiglare properties or a light scattering layer not having antiglare properties; and the light scattering layer may be configured of a single layer or plural layers, for example, from two to four layers.

In the optical film of the invention, functional layers other than the light scattering layer may be provided. Examples of such layers include a hard coat layer, an antistatic layer, a low refractive index layer, and an anti-fouling layer. It is more preferable that the light scattering layer has functions as a hard coat layer, an antistatic layer, an antifouling layer, and so on at the same time. It is preferable that the antistatic layer containing a conductive inorganic fine particle. It is preferable that the low refractive index layer has a refractive index lower than the light scattering layer (the “refractive index” of the light scattering layer as referred to herein is a refractive index of a raw material of a portion other than the translucent particles (that is, a refractive index of the matrix); it is preferable that the low refractive index layer is provided adjacent to the outside of the light scattering layer; and the low refractive index layer may be an outermost layer. An antifouling layer may be further provided on the low refractive index layer. Furthermore, it is more preferable that the low refractive index layer has an antifouling function at the same time.

The most preferred embodiment of the invention is an optical film having a single-layered light scattering layer on a support or an optical film having a single-layered light scattering layer and a single-layered low refractive index layer in this order on a support.

Furthermore, the optical film of the invention preferably has an integrated reflectance of not more than 3.5%, more preferably not more than 3.0%, and further preferably not more than 2.2%.

In addition, it is preferable from the standpoint of realizing a low reflectance that the low refractive index layer is satisfactory with the following numerical expression (I).
(mλ/4)×0.7<n1d1<(mλ/4)×1.3 Numerical Expression (I)

In the expression, m represents a positive odd number; n1 represents a refractive index of the low refractive index layer; d1 represents a thickness (nm) of the low refractive index layer; and X represents a wavelength and is a value in the range of from 500 to 550 nm.

Incidentally, what the low refractive index layer is satisfactory with the foregoing numerical expression (1) means that m (a positive odd number, usually 1) which is satisfactory with the numerical expression (1) within the foregoing wavelength range is present.

It is preferable that the optical film of the invention has internal scattering properties. The internal scattering properties are generally expressed by an internal haze, and usually, a value obtainable by eliminating a surface haze from a total haze to be measured is the internal haze. In incorporating the optical film of the invention having internal scattering properties in an outermost surface of a display device, optical unevenness which other respective constitutional elements of the display device have (for example, luminance unevenness of a light source and chromaticity unevenness of a color filter) can be reduced, and therefore, such is preferable. Furthermore, what the optical film of the invention has internal scattering properties is preferable in view of improving the contrast in an oblique direction of a liquid crystal display. However, when the internal haze is too high, a lowering of the contrast is caused. Thus, the internal haze is preferably from 10 to 90%, more preferably from 30 to 90%, and especially preferably from 50 to 90%.

Furthermore, for the purpose of improving firmness of black color, a surface haze of the optical film of the invention is preferably from 0 to 10%, more preferably from 0.1 to 7%, and further preferably from 0.3 to 5%. The surface haze according to the invention is a value obtainable by individually determining a total haze and an internal haze and subtracting the internal haze from the total haze by calculation.

The optical film of the invention preferably has a transmitted image sharpness of from 30 to 80%, and more preferably from 40 to 70% from the standpoint of making both antiglare properties and firmness of black color compatible with each other.

In the invention, though the coating composition is sometimes referred to as “coating solution”, the both are synonymous with each other.

[Light Scattering Layer]

The light scattering layer according to the invention is a layer which influences the optical performance due to internal scattering and/or surface scattering, and a coating composition therefor contains a translucent part having an average particle size of larger than 5 μm and not more than 15 μm (particle A), a particle having an average particle size of from 0.5 to 5 μm (particle B), a matrix forming component (for example, a monomer for binder), and an organic solvent.

In more detail, the coating composition for forming a light scattering layer contains a monomer for a principal matrix forming binder which becomes a starting material of a translucent polymer to be formed upon hardening with, for example, ionizing radiations, the foregoing translucent particles having a specified particle size, preferably high molecular weight compounds, an additive for enhancing a film strength, an inorganic fine particle filler for reducing curl, adjusting a refractive index or other purpose, a coating auxiliary, and so on.

A thickness of the light scattering layer is usually from 8 to 30 μm, preferably from 8 to 25 μm, and more preferably from 9 to 22 μm. When the thickness falls within the subject range, the light scattering layer is excellent in film hardness and free from defects in, for example, curl, a haze value, and glare and is easy for adjusting antiglare properties, firmness of black color, etc.

[Principal Binder]

It is preferable that the principal matrix forming binder for forming a light scattering layer is a translucent polymer containing, as the principal chain, a saturated hydrocarbon chain or a polyether chain after hardening by ionizing radiations, etc. Furthermore, it is preferable that the principal binder polymer after hardening has a crosslinking structure.

The binder polymer containing, as the principal chain, a saturated hydrocarbon chain after hardening is preferably a polymer of an ethylenically unsaturated monomer selected among compounds of the following first group or a mixture thereof.

Furthermore, the polymer containing, as the principal chain, a polyether chain is preferably a polymer obtainable by ring opening of an epoxy based monomer selected among compounds of the following second group or a mixture thereof.

In addition, polymers of a mixture of these two types of monomers are also preferable.

These compounds will be hereunder described in detail.

(Compound of the First Group)

As the binder polymer containing, as the principal chain, a saturated hydrocarbon chain and having a crosslinking structure, a (co)polymer of a monomer containing two or more ethylenically unsaturated groups is preferable.

In order to make this (co)polymer have a high refractive index, it is preferable that an aromatic ring or at least one member selected from a halogen atom other than fluorine, a sulfur atom, a phosphorus atom and a nitrogen atom is contained in the structure of this monomer.

Examples of the monomer containing two or more ethylenically unsaturated groups which is used for the binder polymer for forming a light scattering layer include esters of a polyhydric alcohol and (meth)acrylic acid {for example, ethylene glycol di(meth)acrylate, 1,4-cyclohexane diacrylate, pentaerythritol tetra(meth)acrylate, pentaerythritol tri(meth)acrylate, trimethylolpropane tri(meth)acrylate, trimethylolethane tri(meth)acrylate, dipentaerythritol tetra(meth)acrylate, dipentaerythritol penta(meth)acrylate, dipentaerythritol hexa(meth)acrylate, pentaerythritol hexa(meth)acrylate, 1,2,3-cyclohexane tetramethacrylate, polyurethane polyacrylate, and polyester polyacrylate}; vinylbenzene and derivatives thereof (for example, 1,4-divinylbenzene, 2-acryloylethyl 4-vinylbenzoate, and 1,4-divinylcyclohexanone); vinylsulfones (for example, divinylsulfone); and (meth)acrylamides (for example, methylenebisacrylamide).

In addition, there are enumerated resins containing two or more ethylenically unsaturated groups, for example, relatively low molecular weight polyester resins, polyether resins, acrylic resins, epoxy resins, urethane resins, alkyd resins, spiro acetal resins, polybutadiene resins, polythiol polyene resins, and oligomers or prepolymers of a polyfunctional compounds such as polyhydric alcohols. Two or more kinds of these monomers may be used jointly. Furthermore, it is preferable that the resin containing two or more ethylenically unsaturated groups is contained in an amount of from 10 to 70% based on the whole amount of the binder.

The polymerization of such an ethylenically unsaturated group-containing monomer can be carried out upon irradiation with ionizing radiations or heating in the presence of a photo radical polymerization initiator or a heat radical polymerization initiator. Accordingly, the light scattering layer is formed by preparing a coating solution containing an ethylenically unsaturated group-containing monomer, a photo radical polymerization initiator or a heat radical polymerization initiator and resin particles and optionally, an inorganic filler, a coating auxiliary, other additives and at least two kinds of an organic solvent, coating the subject coating solutions on a transparent support and then hardening it by a polymerization reaction by ionizing radiations or heat. It is also preferred to combine hardening by ionizing radiations with hardening by heat. As the photo or heat polymerization initiator, commercially available compounds can be utilized. They are described in described in Saishin UV Koka Gijutsu (Latest UV Curing Technologies) (page 159, issuer: Kazuhiro Takasusuki, publishing office: Technical Information Institute Co., Ltd., published in 1991) and catalogues of Ciba Speciality Chemicals.

(Compound of the Second Group)

For the purpose of reducing hardening and shrinkage of a hardened film, it is preferred to use an epoxy based compound as described below. As such an epoxy group-containing monomer, a monomer containing two or more epoxy groups in one molecule thereof is preferable. Examples thereof include epoxy based monomers as described in JP-A-2004-264563, JP-A-2004-264564, JP-A-2005-37737, JP-A-2005-37738, JP-A-2005-140862, JP-A-2005-140862, JP-A-2005-140863, and JP-A-2002-322430.

For the purpose of reducing hardening and shrinkage, the epoxy group-containing monomer is preferably contained in an amount of from 20 to 100% by weight, more preferably from 35 to 100% by weight, and further preferably from 50 to 100% by weight based on the whole of binders constituting the layer.

Examples of a photo acid generator capable of generating a cation by the action of light for the purpose of polymerizing the epoxy based monomer or compound include ionic compounds such as triaryl sulfonium salts and diaryl iodonium salts and nonionic compounds such as nitrobenzyl esters of a sulfonic acid; and various known photo acid generators such as compounds as described in Organic Materials for Imaging, edited by The Japanese Research Association for Organic Electronics Materials and published by Bun-Shin Shuppan K. K. (1997) and the like can be used. Of these, sulfonium salts and iodonium salts are especially preferable; and PF₆⁻, SbF₆⁻, AsF₆⁻, B(C₆H₅)₄⁻, and so on are preferable as a counter ion thereof.

Such a polymerization initiator is preferably used in an amount in the range of from 0.1 to 15 parts by weight, and more preferably in the range of from 1 to 10 parts by weight in terms of the total weight of the polymerization initiator based on 100 parts by weight of the polyfunctional monomer.

It is also preferable that the compound of the first group and the compound of the second group are used together with a high molecular weight compound as described below.

[High Molecular Weight Compound]

The light scattering layer according to the invention may contain a high molecular weight compound. By adding a high molecular weight compound, it is possible to minimize hardening and shrinkage and to more advantageously adjust the density of a coating solution related to the dispersing stability (coagulating properties) of the resin particle. In addition, it is also possible to control the polarity of a solidified material in a drying process, thereby varying the coagulation behavior of the resin particle or reducing drying unevenness in the drying process, and therefore, such is preferable.

The high molecular weight compound already forms a polymer at a point of time of addition in the coating solution. As the high molecular weight compound, resins, for example, cellulose esters (for example, cellulose triacetate, cellulose diacetate, cellulose propionate, cellulose acetate propionate, cellulose acetate butyrate, and cellulose nitrate), urethane acrylates, polyester acrylates, (meth)acrylic esters (for example, methyl methacrylate/methyl (meth)acrylate copolymers, methyl methacrylate/ethyl (meth)acrylate copolymers, methyl methacrylate/butyl (meth)acrylate copolymers, methyl methacrylate/styrene copolymers, methyl methacrylate/(meth)acrylic acid copolymers, and polymethyl methacrylate), and polystyrenes are preferably used.

From the viewpoints of an effect against hardening and shrinkage and an effect for increasing the density of a coating solution, the high molecular weight compound is preferably contained in an amount in the range of from 10 to 60% by weight, and more preferably from 20 to 50% by weight based on the whole of binders which are contained in the layer containing the high molecular weight compound.

Furthermore, a molecular weight of the high molecular weight compound is preferably from 3,000 to 400,000, more preferably from 5,000 to 300,000, and further preferably from 5,000 to 200,000 in terms of weight average molecular weight.

A refractive index of the matrix (a value as measured by eliminating the resin particle from the components of the light scattering layer) is preferably from 1.40 to 2.00, more preferably from 1.45 to 1.90, further preferably from 1.48 to 1.85, and especially preferably from 1.50 to 1.80. From the viewpoint of making coating unevenness or interference unevenness not conspicuous or the costs, the refractive index of the matrix is desirably not more than 1.54, and especially preferably not more than 1.53. Accordingly, the refractive index of the matrix is especially preferably from 1.50 to 1.53.

It is preferable that the components of the matrix of the light scattering layer are added in an amount in the range of from 20 to 95% by weight based on the solids content of the coating solution of the subject layer.

It is preferable that the light scattering layer is formed by coating the subject coating solution on a support and then applying irradiation with light, irradiation with electron beams, heating treatment, etc. thereto, thereby undergoing a crosslinking or polymerization reaction. In the case of irradiation with ultraviolet rays, ultraviolet rays emitted from light beams of an extra-high pressure mercury vapor lamp, a high pressure mercury vapor lamp, a low pressure mercury vapor lamp, a carbon arc lamp, a xenon arc lamp, a metal halide lamp, and so on can be utilized.

Hardening by ultraviolet rays is preferably carried out in an atmosphere where an oxygen concentration is preferably controlled by purging with nitrogen, etc. to an extent of not more than 4% by volume, more preferably not more than 2% by volume, and most preferably not more than 0.5% by volume.

[Translucent Particle]

The light scattering layer of the invention contains a translucent particle having an average particle size of larger than 5 μm and not more than 15 μm (particle A) and a translucent particle having an average particle size of from 0.5 to 5 μm (particle B).

The average particle size of the particle A is more preferably from 6 to 13 μm, and further preferably from 7 to 10 μm. This is used as a principal object for scattering external light as reflected on a display surface to weaken it. In the invention, when the average particle size falls within the foregoing range, the screen is excellent in firmness of black color; a rough feeling is small because of proper antiglare properties; fine luminance unevenness called as glare, which is caused due to surface irregularities at the time of seeing a high-definition display, can be reduced; and a lowering of the frontal contrast is small.

In the invention, the particle A is used for revealing antiglare properties as a principal object; and the particle B is used for the purpose of imparting internal scattering properties. Accordingly, though the refractive index is not particularly regulated, for the purpose of suppressing a lowering of the frontal contrast, it is preferable that the particle A does not generate internal scattering properties. In addition to the matter that the particle A has the foregoing average particle size, it is necessary to adjust a difference in refractive index from the foregoing matrix. Concretely, a difference in refractive index between the particle A and the matrix is preferably not more than 0.05, more preferably not more than 0.04, further preferably not more than 0.025, and especially preferably not more than 0.010. As a matter of course, a combination of two or more kinds of particles having the size of the particle A and a different refractive index from each other can be preferably used, too. In that case, it is preferable that 20% or more, more preferably 40% or more, and further preferably 60% or more of particles in the whole of particles of the subject size fall within the foregoing refractive index range.

The average particle size of the particle B is from 0.5 to 5 μm, and more preferably from 1 to 4 μm. This is used as a principal object for imparting internal scattering properties. In the invention, when the average particle size of the particle B falls within the foregoing range, preferred internal scattering properties can be imparted; and it becomes possible to improve the contrast in an oblique direction or to reduce glare while inhibiting a lowering of the contrast in a front direction. Furthermore, the preferred surface irregularities as imparted by the particle A are not adversely affected.

In the invention, since the particle B is used as a principal object for imparting internal scattering properties, it is necessary to adjust a difference in refractive index from the foregoing matrix. Concretely, a difference in refractive index between the particle B and the matrix is preferably 0.04 or more, especially preferably 0.05 or more, and further preferably 0.06 or more. As a matter of course, a combination of two or more kinds of particles having the size of the particle B and a different refractive index from each other can be preferably used, too. In that case, it is preferable that 20% or more, more preferably 40% or more, and further preferably 60% or more of particles in the whole of particles of the subject size fall within the foregoing refractive index range.

It is preferable that the difference between the refractive index of the particle A and the refractive index of the matrix is smaller than the difference in refractive index between the particle B and the matrix.

The amount of addition of the particle A is preferably from 2 to 40% by weight, and especially preferably from 4 to 25% by weight in the whole of solids of the light scattering layer.

The amount of addition of the particle B is preferably from 2 to 40% by weight, and especially preferably from 4 to 25% by weight in the whole of solids of the light scattering layer.

The particle A and the particle B can be selected among resin particles as described below depending upon desired refractive index and average particle size.

The translucent particle according to the invention is not particularly limited so far as it meets the foregoing regulations. As specific examples of the resin particle, there are preferably enumerated resin particles, for example, a crosslinked polymethyl methacrylate particle, a crosslinked methyl methacrylate-styrene copolymer particle, a crosslinked polystyrene particle, a crosslinked methyl methacrylate-methyl acrylate copolymer particle, a crosslinked acrylate-styrene copolymer particle, a melamine-formaldehyde resin particle, and a benzoguanamine-formaldehyde resin particle. In addition, so-called surface-modified particles resulting from chemical binding of a compound containing a fluorine atom, a silicon atom, a carboxyl group, a hydroxyl group, an amino group, a sulfonic acid group, a phosphoric acid group, etc. on a surface of such a resin particle are also preferably enumerated. Above all, a crosslinked styrene particle, a crosslinked polymethyl methacrylate particle, a crosslinked methyl methacrylate-styrene copolymer particle, and so on are preferable. Furthermore, an inorganic fine particle can also be used as the translucent particle. As examples of the inorganic fine particle, a silica particle, an alumina particle and the like are preferably used, and a silica particle is especially preferably used.

In the case of making the matrix have a refractive index of not more than 1.54, and especially preferably not more than 1.53 from the viewpoint of making coating unevenness or interference unevenness not conspicuous or the costs, a crosslinked polymethyl methacrylate particle, a crosslinked methyl methacrylate-styrene copolymer particle, and a silica particle are especially preferable as the particle A. In the case of using a crosslinked methyl methacrylate-styrene copolymer particle, a copolymerization ratio of the acrylate is especially preferably 50% or more. A crosslinked polymethyl methacrylate particle and a crosslinked methyl methacrylate-styrene copolymer particle are especially preferable as the particle B. In the case of using a crosslinked methyl methacrylate-styrene copolymer particle, a copolymerization ratio of the acrylate is especially preferably not more than 50%.

With respect to the shape of the resin particle, all of a truly spherical shape and an amorphous shape can be used. The particle size distribution is preferably of a monodispersed particle in view of control properties of a haze value and diffusibility and homogeneity of coating surface properties. For example, in the case where a particle having a particle size of at least 20% larger than the average particle size is defined as a coarse particle, a proportion of this coarse particle is preferably not more than 1%, more preferably not more than 0.1%, and further preferably not more than 0.01% of the number of all particles. A particle having such a particle size distribution is obtained by classification after a usual synthetic reaction. By increasing the number of classification or strengthening its degree, it is possible to obtain a particle having a more preferred distribution.

The particle size distribution of the particle is measured by a Coulter counter, and a measured distribution is converted into a particle number distribution. The average particle size is calculated from the obtained particle distribution.

In the light scattering layer of the invention, in addition to the foregoing particle A and particle B, an “inorganic filler” as described later can be used, too for the purpose of adjusting the refractive index or adjusting the film strength.

[Organic Solvent]

At least one organic solvent is contained in the coating composition for forming a light scattering layer.

Examples of the organic solvent include alcohol bases such as methanol, ethanol, n-propanol, isopropanol, n-butanol, isobutanol, sec-butanol, tert-butanol, isoamyl alcohol, 1-pentanol, n-hexanol, and methylamyl alcohol; ketone bases such as methyl isobutyl ketone, methyl ethyle ketone, diethyl ketone, acetone, cyclohexanone, and diacetone alcohol; ester bases such as methyl acetate, ethyl acetate, n-propyl acetate, isopropyl acetate, isobutyl acetate, n-butyl acetate, isoamyl acetate, n-amyl acetate, methyl propionate, ethyl propionate, butyl butyrate, ethyl butyrate, methyl acetate, methyl lactate, and ethyl lactate; ether or acetal bases such as 1,4-dioxane, tetrahydrofuran, 2-methylfuran, tetrahydropyrane, and diethyl acetal; hydrocarbon bases such as hexane, heptane, octane, isooctane, ligroin, cyclohexane, methylcyclohexane, toluene, xylene, ethylbenzene, styrene, and divinylbenzene; halogenated hydrocarbon bases such as carbon tetrachloride, chloroform, methylene chloride, ethylene chloride, 1,1,1-trichloroethane, 1,1,2-trichloroethane, trichloroethylene, tetrachloroethylene, and 1,1,1,2-tetrachloroethane; polyhydric alcohol and its derivative bases such as ethylene glycol, ethylene glycol monomethyl ether, ethylene glycol monoethyl ether, ethylene glycol monoacetate, diethylene glycol, propylene glycol, dipropylene glycol, butanediol, hexylene glycol, 1,5-pentanediol, glycerin monoacetate, glycerin ethers, and 1,2,6-hexanetriol; fatty acid bases such as formic acid, acetic acid, propionic acid, butyric acid, isobutyric acid, isovaleric acid, and lactic acid; nitrogen compound bases such as formamide, N,N-dimethylformamide, acetamide, and acetonitrile; and sulfur compound bases such as dimethyl sulfoxide.

Of these, methyl isobutyl ketone, methyl ethyl ketone, cyclohexanone, acetone, toluene, xylene, ethyl acetate, 1-pentanol, and so on are especially preferable. Furthermore, for the purpose of controlling the coagulation properties, an alcohol or polyhydric alcohol based solvent may be properly mixed and used.

Such an organic solvent may be used singly or in admixture and is preferably contained in an amount of from 40% by weight to 98% by weight, more preferably from 60% by weight to 97% by weight, and most preferably from 70% by weight to 95% by weight in the terms of a total amount of the organic solvents in the coating solution.

[Organosilicon Compound]

For the purposes of lowering the hardening and shrinkage and enhancing the film hardness, it is preferable that an organosilicon compound represented by the following formula (1) or a reaction product of its polymer is contained.
Rₘ₂Si(OR¹)₄₋ₘ Formula (1)

In the formula (1), R¹ and R² may be the same or different and each represents a substituted or unsubstituted alkyl group; and m is 0 or 1.

Specific examples of the organosilicon compound represented by the formula (1) include Si(OCH₃)₄, Si(OC₂H₅)₄, Si(OC₃H₇)₄, Si[OCH(CH₃)₂]₄, Si(OC₄H₉)₄, CH₃CH₂Si(OCH₃)₃, CH₃(CH₂)₂Si(OCH₃)₃, CH₃(CH₂)₃Si(OCH₃)₃, (CH₃)₂(CH)Si(OCH₃)₃, CH₃Si(OC₂H₅)₃, CH₃CH₂Si(OC₂H₅)₃, CH₃(CH₂)₂Si(OC₂H₅)₃, CF₃CF₂(CH₂)₂Si(OCH₃)₃, and CF₃(CF₂)₂(CH₂)₂Si(OCH₃)₃. Such a compound may be used singly or in combination of two or more kinds thereof.

A method of preparing a polymer by using the organosilicon compound represented by the foregoing formula (1) is not limited. A catalyst which is used in preparing the polymer by hydrolysis is known, and examples thereof include hydrochloric acid, oxalic acid, nitric acid, acetic acid, hydrofluoric acid, formic acid, phosphoric acid, oxalic acid, ammonia, aluminum acetonate, dibutyltin laurate, a tin octylate compound, methanesulfonic acid, trichloromethanesulfonic acid, p-toluenesulfonic acid, and trifluoroacetic acid. Such a catalyst may be used singly or in combination of two or more kinds thereof.

[Inorganic Filler]

For increasing the hardness of the layer, reducing the hardening and shrinkage and enhancing the refractive index of the matrix for the purpose of lowering the reflectance in the case of providing a low refractive index layer, it is also preferable that in addition to the foregoing particles, a fine inorganic filler with a high refractive index which is made of at least one oxide of a metal selected from titanium, zirconium, aluminum, indium, zinc, tin and antimony and which generally has an average particle size of not more than 0.2 μm, preferably not more than 0.1 μm, and more preferably not more than 0.06 μm in terms of a primary particle thereof is contained in the light scattering layer.

Conversely, in the case where it is necessary that the refractive index of the matrix is lowered for the purpose of adjusting a difference from the refractive index of the particle A or the particle B, a fine inorganic filler with a low refractive index such as silica fine particles and hollow silica fine particles can be used as the inorganic filler. A preferred particle size thereof is the same as in the foregoing fine inorganic filler with a high refractive index.

Specific examples of the fine inorganic filler which is used in the light scattering layer include TiO₂, ZrO₂, Al₂O₃, In₂O₃, ZnO, SnO₂, Sb₂O₃, ITO (Sn-doped indium oxide), and SiO₂. Of these, TiO₂ and ZrO₂ are especially preferable in view of realizing a high refractive index; and SiO₂ is especially preferable in view of realizing a low refractive index. It is also preferable that a surface of the subject inorganic filler is subjected to a silane coupling treatment or a titanium coupling treatment, and a surface treating agent containing a functional group capable of reacting with a species of the binder on the filler surface is preferably used.

The amount of addition of such a fine inorganic filler is preferably from 10 to 90% by weight, more preferably from 20 to 80% by weight, and especially preferably from 30 to 75% by weight of the total weight of the light scattering layer.

Incidentally, since the fine inorganic filler has a particle size sufficiently shorter than the wavelength of light, it has such natures that scattering is not generated and that a dispersion having the subject filler dispersed in a binder polymer is an optically uniform substance.

[Other Additives]

With respect to the light scattering layer configuring the optical film of the invention, it is preferable that at least any one of an organosilane compound and a hydrolyzate of an organosilane compound and a partial condensate thereof (so-called sol component) as described in detail in a section of “Low refractive index layer” as described later is contained in a coating solution for forming that layer, thereby improving scar resistance.

(Surfactant for Light Scattering Layer)

In the light scattering layer of the invention, in particular, for the purpose of ensuring uniformity in surface properties by suppressing a fault of surface properties such as coating unevenness, drying unevenness, and point defect, it is preferable that any one or both of a fluorine based surfactant and a silicone based surfactant are contained in a coating composition for forming a light scattering layer. In particular, a fluorine based surfactant is preferably used because it reveals an effect for improving a fault of surface properties of the optical film of the invention such as coating unevenness, drying unevenness, and point defect in a smaller amount of addition.

The invention is aimed to enhance the productivity by bringing high-speed coating adaptability while enhancing the uniformity in surface properties.

Preferred examples of the fluorine based surfactant include a fluoro aliphatic group-containing copolymer (sometimes abbreviated as “fluorine based polymer”). As the subject fluorine based polymer, acrylic resins and methacrylic resin, and copolymers thereof with a copolymerizable vinyl based monomer, which are characterized by containing a repeating unit corresponding to the following monomer (i) or characterized by containing a repeating unit corresponding to the following monomer (i) and a repeating unit corresponding to the following monomer (ii), are useful.
(i) Fluoro aliphatic group-containing monomer represented by the following formula (I):

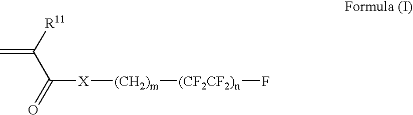

In the formula (I), R¹¹ represents a hydrogen atom or a methyl group; X represents an oxygen atom, a sulfur atom, or —N(R¹²)—; m represents an integer of 1 or more and not more than 6; and n represents an integer of from 2 to 4. R¹² represents a hydrogen atom or an alkyl group having from 1 to 4 carbon atoms, specifically a methyl group, an ethyl group, a propyl group or a butyl group, with a hydrogen atom and a methyl group being preferable. X is preferably an oxygen atom.
(ii) Monomer represented by the following formula (II), which is copolymerizable with the foregoing monomer (i):

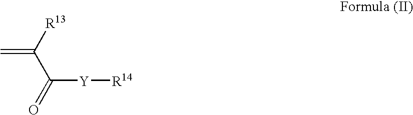

In the formula (II), R¹³ represents a hydrogen atom or a methyl group; Y represents an oxygen atom, a sulfur atom, or —N(R¹⁵)—; and R¹⁵ represents a hydrogen atom or an alkyl group having from 1 to 4 carbon atoms, specifically a methyl group, an ethyl group, a propyl group or a butyl group, with a hydrogen atom and a methyl group being preferable. Y is preferably an oxygen atom, —N(H)—, or —N(CH₃)—.

R¹⁴ represents an optionally substituted linear, branched or cyclic alkyl group having 4 or more and not more than 20 carbon atoms or a poly(alkyleneoxy) group-containing alkyl group.

Examples of a substituent of the alkyl group represented by R¹⁴ include a hydroxyl group, an alkylcarbonyl group, an arylcarbonyl group, a carboxyl group, an alkyl ether group, an aryl ether group, a halogen atom (for example, a fluorine atom, a chlorine atom, and a bromine atom), a nitro group, a cyano group, and an amino group. However, it should not be construed that the invention is limited thereto. As the linear, branched or cyclic alkyl group having 4 or more and not more than 20 carbon atoms, there are suitably used a butyl group, a pentyl group, a hexyl group, a heptyl group, an octyl group, a nonyl group, a decyl group, an undecyl group, a dodecyl group, a tridecyl group, a tetradecyl group, a pentadecyl group, an octadeyl group, and an eicosanyl group, each of which may be linear or branched; monocyclic cycloalkyl groups such as a cyclohexyl group and a cycloheptyl group; and polycyclic cycloalkyl groups such as a bicycloheptyl group, a bicyclodecyl group, a tricycloundecyl group, a tetracyclododecyl group, an adamantyl group, a norbornyl group, and a tetracyclodecyl group.

The amount of the fluoro aliphatic group-containing monomer represented by the formula (I) which is used in the fluorine based polymer which is used in the light scattering layer of the invention is in the range of 10% by mole or more, preferably from 15 to 70% by mole, and more preferably from 20 to 60% by mole based on each of the monomers of the subject fluorine based polymer.

The fluorine based polymer preferably has a weight average molecular weight of from 3,000 to 100,000, and more preferably from 5,000 to 80,000.

In addition, the amount of addition of the fluorine based polymer which is used in the light scattering layer of the invention is preferably in the range of from 0.001 to 5% by weight, more preferably in the range of from 0.005 to 3% by weight, and further preferably in the range of from 0.01 to 1% by weight based on the coating solution. When the amount of addition of the fluorine based polymer is 0.001% by weight or more, the effect is sufficient; and when it is not more than 5% by weight, drying of the coating film is sufficiently carried out, and a satisfactory performance (for example, reflectance and scar resistance) as the coating film is obtained.

Specific examples of a structure of a fluorine based polymer containing a repeating unit corresponding to the fluoro aliphatic group-containing monomer represented by the formula (I) will be given below, but it should not be construed that the invention is limited thereto. Incidentally, numerals in the formulae represent a molar ratio of respective monomer components; and Mw represents a weight average molecular weight.

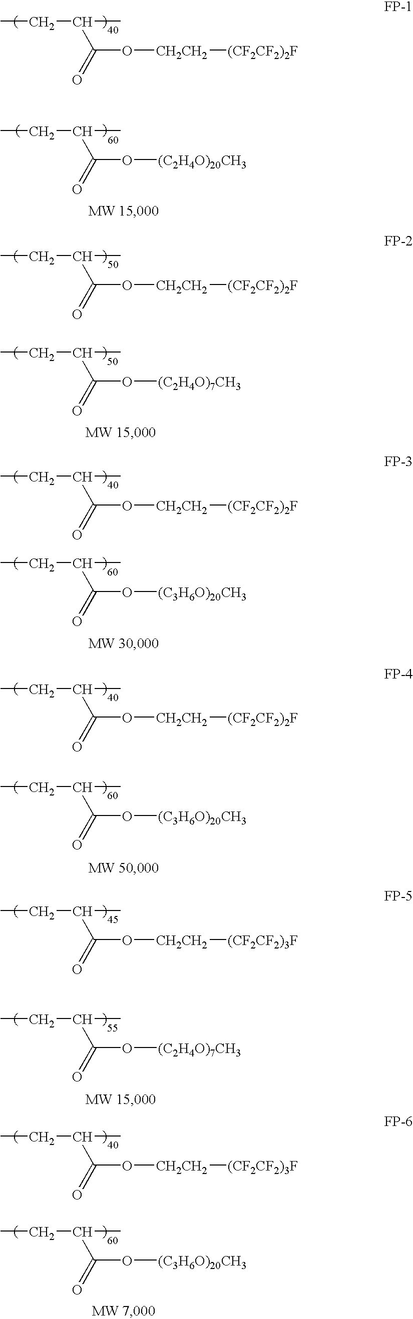

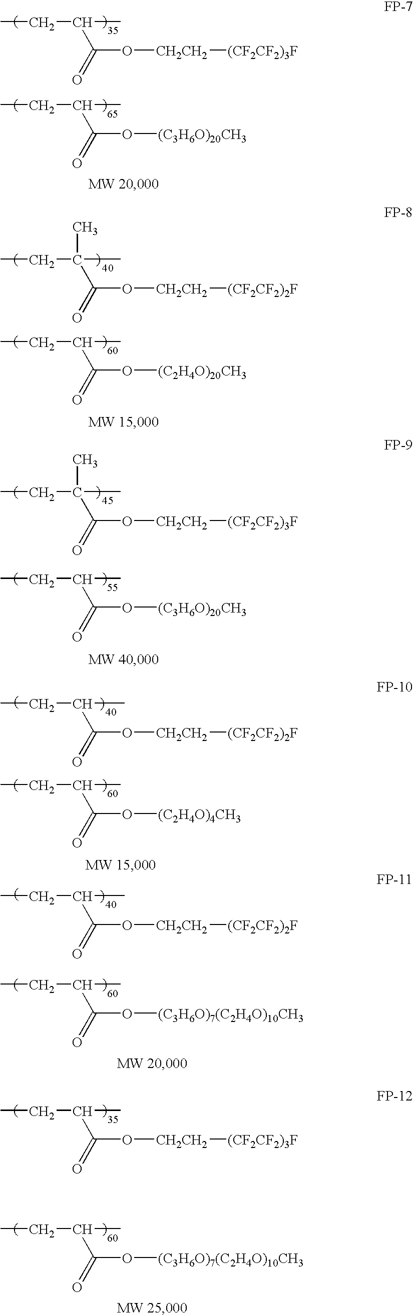

However, when the foregoing fluorine based polymer is used, surface energy of the layer is lowered due to segregation of an F atom-containing functional group on the surface of the layer. As a result, when the low refractive index layer is subjected to overcoating on the foregoing light scattering layer, there is caused a problem that the antireflection performance is deteriorated. It is estimated that since wettability of a hardenable composition which is used for forming a low refractive index layer is deteriorated, fine unevenness which cannot be visually detected is formed in the low refractive index layer. In order to solve such a problem, it has been found that it is effective to control the surface energy of the layer preferably at from 20 mN·m⁻¹ to 50 mN·m⁻¹, and more preferably at from 30 mN·m⁻¹ to 40 mN·m⁻¹ by adjusting the structure and the amount of addition of the fluorine based polymer. In order to realize the foregoing surface energy, it is necessary that F/C which is a ratio of a peak derived from a fluorine atom to a peak derived from a carbon atom as measured by X-ray photoelectron spectroscopy is from 0.1 to 1.5.

Furthermore, when an upper layer is coated, by selecting a fluorine based polymer which is extractable with a solvent for forming the upper layer, the fluorine based polymer is not unevenly distributed on the surface of a lower layer (=interface), thereby bringing adhesion between the upper layer and the lower layer. Then, uniformity in surface properties is kept even in high-speed coating, and a lowering of surface free energy capable of providing an optical film having strong scar resistance is prevented from occurring, thereby controlling the surface energy of the light scattering layer prior to coating of a low refractive index layer within the foregoing range. Thus, the object of the invention can be achieved. Examples of such a raw material include acrylic resins or methacrylic resins which are characterized by containing a repeating unit corresponding to a fluoro aliphatic group-containing monomer represented by the following formula (III), and copolymers thereof with a copolymerizable vinyl based monomer (for example, a monomer represented by the following monomer (IV)).
(iii) Fluoro aliphatic group-containing monomer represented by the following formula (III):

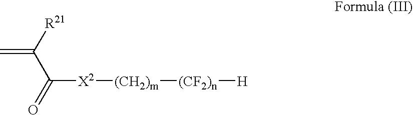

In the formula (III), R²¹ represents a hydrogen atom, a halogen atom, or a methyl group, and more preferably a hydrogen atom or a methyl group. X² represents an oxygen atom, a sulfur atom, or —N(R²²)—, more preferably an oxygen atom or —N(R²²)—, and further preferably an oxygen atom. m represents an integer of 1 or more and not more than 6 (more preferably from 1 to 3, and further preferably 1); and n represents an integer of 1 or more and not more than 18 (more preferably from 4 to 12, and further preferably from 6 to 8). R²² represents a hydrogen atom or an optionally substituted alkyl group having from 1 to 8 carbon atoms, more preferably a hydrogen atom or an alkyl group having from 1 to 4 carbon atoms, and further preferably a hydrogen atom or a methyl group.

Furthermore, two or more kinds of the fluoro aliphatic group-containing monomer represented by the formula (III) may be contained as a constitutional component in the fluorine based polymer.
(iv) Monomer represented by the following formula (IV), which is copolymerizable with the foregoing monomer (iii):

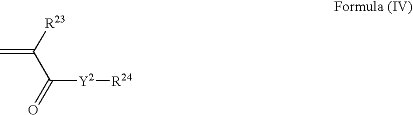

In the formula (IV), R²³ represents a hydrogen atom, a halogen atom, or a methyl group, and more preferably a hydrogen atom or a methyl group. Y² represents an oxygen atom, a sulfur atom, or —N(R²⁵)—, more preferably an oxygen atom or —N(R²⁵)—, and further preferably an oxygen atom. R²⁵ represents a hydrogen atom or an alkyl group having from 1 to 8 carbon atoms, more preferably a hydrogen atom or an alkyl group having from 1 to 4 carbon atoms, and further preferably a hydrogen atom or a methyl group.

R²⁴ represents an optionally substituted linear, branched or cyclic alkyl group having from 1 to 20 carbon atoms, a poly(alkyleneoxy) group-containing alkyl group, or an optionally substituted aromatic group (for example, a phenyl group and a naphthyl group), more preferably a linear, branched or cyclic alkyl group having from 1 to 12 carbon atoms or an aromatic group having from 6 to 18 carbon atoms in total, and further preferably a linear, branched or cyclic alkyl group having from 1 to 8 carbon atoms.

Specific examples of a structure of a fluorine based polymer containing a repeating unit corresponding to the fluoro aliphatic group-containing monomer represented by the formula (III) will be given below, but it should not be construed that the invention is limited thereto. Incidentally, numerals in the formulae represent a molar ratio of respective monomer components; and Mw represents a weight average molecular weight.

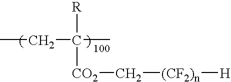

| | R | n | Mw |
|---|---|---|---|
| P-1 | H | 4 | 8000 |
| P-2 | H | 4 | 16000 |
| P-3 | H | 4 | 33000 |
| P-4 | CH₃ | 4 | 12000 |
| P-5 | CH₃ | 4 | 28000 |
| P-6 | H | 6 | 8000 |
| P-7 | H | 6 | 14000 |
| P-8 | H | 6 | 29000 |
| P-9 | CH₃ | 6 | 1000 |
| P-10 | CH₃ | 6 | 21000 |
| P-11 | H | 8 | 4000 |
| P-12 | H | 8 | 16000 |
| P-13 | H | 8 | 31000 |
| P-14 | CH₃ | 8 | 3000 |

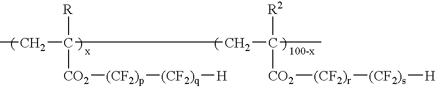

| | x | R¹ | p | q | R² | r | s | Mw |
|---|---|---|---|---|---|---|---|---|
| P-15 | 50 | H | 1 | 4 | CH₃ | 1 | 4 | 10000 |
| P-16 | 40 | H | 1 | 4 | H | 1 | 6 | 14000 |
| P-17 | 60 | H | 1 | 4 | CH₃ | 1 | 6 | 21000 |
| P-18 | 10 | H | 1 | 4 | H | 1 | 8 | 11000 |
| P-19 | 40 | H | 1 | 4 | H | 1 | 8 | 16000 |
| P-20 | 20 | H | 1 | 4 | CH₃ | 1 | 8 | 8000 |
| P-21 | 10 | CH₃ | 1 | 4 | CH₃ | 1 | 8 | 7000 |
| P-22 | 50 | H | 1 | 6 | CH₃ | 1 | 6 | 12000 |
| P-23 | 50 | H | 1 | 6 | CH₃ | 1 | 6 | 22000 |
| P-24 | 30 | H | 1 | 6 | CH₃ | 1 | 6 | 5000 |

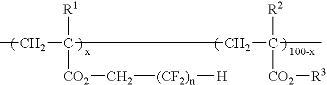

| | x | R¹ | n | R² | R³ | Mw |
|---|---|---|---|---|---|---|
| FP-148 | 80 | H | 4 | CH₃ | CH₃ | 11000 |
| FP-149 | 90 | H | 4 | H | C₄H₉(n) | 7000 |
| FP-150 | 95 | H | 4 | H | C₆H₁₃(n) | 5000 |
| FP-151 | 90 | CH₃ | 4 | H | CH₂CH(C₂H₅)C₄H₉(n) | 15000 |
| FP-152 | 70 | H | 6 | CH₃ | C₂H₅ | 18000 |
| FP-153 | 90 | H | 5 | CH₃ | 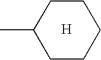 | 12000 |
| FP-154 | 80 | H | 6 | H | C₄H₉(sec) | 9000 |
| FP-155 | 90 | H | 6 | H | C₁₂H₂₅(n) | 21000 |
| FP-156 | 60 | CH₃ | 6 | H | CH₃ | 15000 |
| FP-157 | 60 | H | 8 | H | CH₃ | 1000 |
| FP-158 | 70 | H | 8 | H | C₂H₅ | 24000 |
| FP-159 | 70 | H | 8 | H | C₄H₉(n) | 5000 |
| FP-160 | 50 | H | 8 | H | C₄H₉(n) | 16000 |
| FP-161 | 80 | H | 8 | CH₃ | C₄H₉(iso) | 13000 |
| FP-162 | 80 | H | 8 | CH₃ | C₄H₉(t) | 9000 |
| FP-163 | 60 | H | 8 | H | 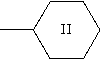 | 7000 |
| FP-164 | 80 | H | 8 | H | CH₂CH(C₂H₅)C₄H₉(n) | 8000 |
| FP-165 | 90 | H | 8 | H | C₁₂H₂₅(n) | 6000 |
| FP-166 | 80 | C₃ | 8 | CH₃ | C₄H₉(sec) | 18000 |
| FP-167 | 70 | CH₃ | 8 | CH₃ | CH₃ | 22000 |
| FP-168 | 70 | H | 10 | CH₃ | H | 17000 |
| FP-169 | 90 | H | 10 | H | H | 9000 |

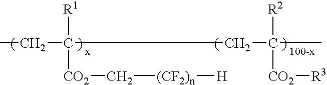

| | x | R¹ | n | R² | R³ | Mw |
|---|---|---|---|---|---|---|
| FP-170 | 95 | H | 4 | CH₃ | —(CH₂CH₂O)₂—H | 18000 |
| FP-171 | 80 | H | 4 | H | —(CH₂CH₂O)₂—CH₃ | 16000 |
| FP-172 | 80 | H | 4 | H | —(C₃H₆O)₇—H | 24000 |
| FP-173 | 70 | CH₃ | 4 | H | —(C₃H₆O)₁₃—H | 18000 |
| FP-174 | 90 | H | 6 | H | —(CH₂CH₂O)₂—H | 21000 |
| FP-175 | 90 | H | 6 | CH₃ | —(CH₂CH₂O)₂'H | 9000 |
| FP-176 | 80 | H | 6 | H | —(CH₂CH₂O)₂—C₄H₉(n) | 12000 |
| FP-177 | 80 | H | 6 | H | —(C₃H₆O)₇—H | 34000 |
| FP-178 | 75 | F | 6 | H | —(C₃H₆O)₁₃—H | 11000 |
| FP-179 | 85 | CH₃ | 6 | CH₃ | —(C₃H₆O)₂₀—H | 18000 |
| FP-180 | 95 | CH₃ | 6 | CH₃ | —CH₂CH₂OH | 27000 |
| FP-181 | 80 | H | 8 | CH₃ | —(CH₂CH₂O)₅—H | 12000 |
| FP-182 | 95 | H | 8 | H | —(CH₂CH₂O)₉—H | 2000 |
| FP-183 | 90 | H | 8 | H | —(C₃H₆O)₇— | 8000 |
| FP-184 | 95 | H | 8 | H | —(C₃H₆O)₂₀—H | 15000 |
| FP-185 | 90 | F | 8 | H | —(C₃H₆O)₁₃—H | 12000 |
| FP-186 | 80 | H | 8 | CH₃ | +113 (CH₂CH₂O)₅—H | 2000 |
| FP-187 | 95 | CH₃ | 8 | H | —(CH₂CH₂O)₉—CH₃ | 17000 |
| FP-188 | 90 | CH₃ | 8 | H | —(C₃H₆O)₇—H | 34000 |
| FP-189 | 80 | H | 10 | H | —(CH₂CH₂O)₉'H | 19000 |
| FP-190 | 90 | H | 10 | H | —(C₃H₆O)₇—H | 8000 |
| FP-191 | 80 | H | 12 | H | —(CH₂CH₂O)₇—CH₃ | 7000 |
| FP-192 | 95 | CH₂ | 12 | H | —(C₃H₆O)₇—H | 10000 |

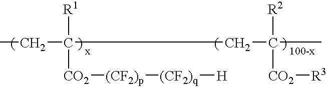

| | x | R¹ | p | q | R² | R³ | Mw |
|---|---|---|---|---|---|---|---|
| FP- | 80 | H | 2 | 4 | H | C₄H₉(n) | 18000 |
| 193 | | | | | | | |
| FP- | 90 | H | 2 | 4 | H | —(CH₂CH₂O)₆—CH₃ | 16000 |
| 194 | | | | | | | |
| FP- | 90 | CH₂ | 2 | 4 | F | C₆H₁₃(n) | 224000 |
| 195 | | | | | | | |
| FP- | 80 | CH₃ | 1 | 6 | F | C₄H₉(n) | 18000 |
| 196 | | | | | | | |
| FP- | 95 | H | 2 | 6 | H | —(C₃H₆O)₇+113 H | 21000 |
| 197 | | | | | | | |
| FP- | 90 | CH₃ | 3 | 6 | H | —CH₂CH₂OH | 9000 |
| 198 | | | | | | | |
| FP- | 75 | H | 1 | 8 | F | CH₃ | 12000 |
| 199 | | | | | | | |
| FP- | 80 | H | 2 | 8 | H | CH₂CH(C₂H₅)C₄H₉(n) | 34000 |
| 200 | | | | | | | |
| FP- | 90 | CH₃ | 2 | 8 | H | —(C₃H₆O)₇—H | 11000 |
| 201 | | | | | | | |
| FP- | 80 | H | 3 | 8 | CH₃ | CH₃ | 18000 |
| 202 | | | | | | | |
| FP- | 90 | H | 1 | 10 | F | C₄H₉(n) | 27000 |
| 203 | | | | | | | |
| FP- | 95 | H | 2 | 10 | H | —(CH₂CH₂O)₉—CH₃ | 12000 |
| 204 | | | | | | | |
| FP- | 85 | CH₃ | 2 | 10 | CH₃ | C₄H₉(n) | 20000 |
| 205 | | | | | | | |
| FP- | 80 | H | 1 | 12 | H | C₆H₁₃(n) | 8000 |
| 206 | | | | | | | |
| FP- | 90 | H | 1 | 12 | H | —(C₃H₆O)₁₃—H | 15000 |
| 207 | | | | | | | |
| FP- | 60 | CH₃ | 3 | 12 | CH₃ | C₂H₅ | 12000 |
| 208 | | | | | | | |
| FP- | 60 | H | 1 | 16 | H | CH₂CH(C₂H₅)C₄H₉(n) | 20000 |
| 209 | | | | | | | |
| FP- | 80 | CH₃ | 1 | 16 | H | —(CH₂CH₂O)₂—C₄H₉(n) | 17000 |
| 210 | | | | | | | |
| FP- | 90 | H | 1 | 18 | H | —CH₂CH₂OH | 34000 |
| 211 | | | | | | | |
| FP- | 60 | H | 3 | 18 | CH₃ | CH₃ | 19000 |
| 212 | | | | | | | |

Furthermore, if a lowering of the surface energy can be prevented at a point of time when the low refractive index layer is subjected to overcoating on the light scattering layer, deterioration of the antireflection performance can be prevented. By using a fluorine based polymer at the time of coating the light scattering layer to lower a surface tension of the coating solution, thereby enhancing uniformity in surface properties and keeping high productivity by high-speed coating and after coating an antiglare layer, employing a surface treatment measure such as a corona treatment, a UV treatment, a heat treatment, a saponification treatment, and a solvent treatment, thereby preventing a lowering of surface free energy, the surface energy of the light scattering layer prior to coating of a low refractive index layer is controlled within the foregoing range, thereby enabling one to achieve the object.

Furthermore, a thixotropic agent may be added in the coating composition for forming the light scattering layer of the invention. Examples of the thixotropic agent include silica and mica each having a particle size of not more than 0.1 μm. It is suitable that the content of such an additive is usually from approximately from 1 to 10 parts by weight based on 100 parts by weight of the ultraviolet ray hardenable resin.

It is preferable that in the optical film of the invention, an intensity distribution of scattered light as measured by a goniophotometer correlates with an effect for improving a viewing angle. That is, when the diffusion of outgoing light from backlight is increased due to an effect of internal scattering of the translucent fine particle which is contained in the optical film placed on a surface of a polarizing plate in a viewing side, the viewing angle characteristics become better. However, when the light is excessively diffused, there are caused such problems that backscattering becomes large and a front luminance is reduced and that image sharpness is deteriorated because of excessive scattering. Accordingly, it is necessary to control the distribution of scattered light intensity within a certain range. Then, as a result of extensive and intensive investigations, in order to achieve a desired viewing characteristic, a scattered light intensity at 30° which is especially correlated with the effect for improving a viewing angle against a light intensity at an outgoing angle of 0° is preferably from 0.01% to 0.2%, more preferably from 0.02% to 0.15%, and especially preferably from 0.03% to 0.1%.

The scattered light profile can be measured with respect to a prepared light scattering film by using GoniophotoMeter: GP-5 Model, manufactured by Murakami Color Research Laboratory Co. Ltd.

[Low Refractive Index Layer]

In the optical film of the invention, it is also preferable that on the light scattering layer, a low refractive index layer having a refractive index lower than the subject light scattering layer is stacked. The low refractive index layer is preferably, for example, a hardened film as formed by coating a hardenable composition containing a fluorine-containing polymer and/or an ionizing radiation hardenable polyfunctional monomer as the principal component, followed by drying and hardening. In addition, it is also preferable that an organosilane compound or a hydrolyzate thereof and/or a partial condensate thereof is contained.

A refractive index of the low refractive index layer in the optical film of the invention is preferably in the range of from 1.20 to 1.48, and more preferably from 1.30 to 1.46.

[Fluorine-containing Polymer for Low Refractive Index Layer]

In the case of, for example, coating and hardening a rolled film while being web conveyed, it is preferable in view of improving the productivity that the fluorine-containing polymer is a polymer having a dynamic friction coefficient of a film formed upon hardening of from 0.03 to 0.20, a contact angle against water of from 90 to 120° and a slipping down angle of pure water of not more than 70° and capable of being crosslinked by heat or ionizing radiations.

Furthermore, in the case where the optical film of the invention is installed in an image display device, when a peel force against a commercially available adhesive tape is low, the optical film is liable to be peeled away after sticking a seal or memory thereto. Accordingly, the peel force is preferably not more than 500 gf (4.9 N), more preferably not more than 300 gf (2.9 N), and most preferably not more than 100 gf (0.98 N). Furthermore, when a surface hardness as measured by a micro hardness tester is high, the optical film is liable to be hardly scared. Accordingly, the subject surface hardness is preferably 0.3 GPa or more, and more preferably 0.5 GPa.

The fluorine-containing polymer which is used for the low refractive index layer is preferably a fluorine-containing polymer containing a fluorine atom in an amount in the range of from 35 to 80% by weight and containing a crosslinking or polymerizable functional group. Examples thereof include fluorine-containing copolymers of a fluorine-containing monomer unit and a crosslinking reactive unit as constitutional units, in addition to hydrolyzates or dehydration condensates of a perfluoroalkyl group-containing silane compound [for example, (heptadecafluoro-1,1,2,2-tetrahydrodecyl)triethoxysilane]. In the case of the fluorine-containing copolymer, it is preferable that the principal chain thereof is composed of only a carbon atom. That is, it is preferable that the principal chain skeleton does not contain an oxygen atom, a nitrogen atom or the like.

Specific examples of the foregoing fluorine-containing monomer include fluoroolefins (for example, fluoroethylene, vinylidene fluoride, tetrafluoroethylene, perfluorooctylethylene, hexafluoropropylene, and perfluoro-2,2-dimethyl-1,3-dioxol), partially or completely fluorinated alkyl ester derivatives of (meth)acrylic acid (for example, “VISCOAT 6FM” (manufactured by Osaka Organic Chemical Industry Ltd.) and “M-2020” (manufactured by Daikin Industries, Ltd.)), and completely or partially fluorinated vinyl ethers. Of these, perfluoroolefins are preferable; and hexafluoropropylene is especially preferable from the viewpoints of refractive index, solubility, transparency, easiness of availability, and so on.

Examples of the foregoing crosslinking reactive unit include a constitutional unit obtainable by polymerization of a monomer which contains a self-crosslinking functional group in the molecule thereof in advance (for example, glycidyl (meth)acrylate and glycidyl vinyl ether); and a constitutional unit in which a crosslinking reactive group such as a (meth)acryloyl group is introduced into a constitutional unit obtainable by polymerization of a monomer containing a carboxyl group, a hydroxyl group, an amino group, a sulfo group, etc. [for example, (meth)acrylic acid, methylol (meth)acrylate, hydroxyalkyl (meth)acrylates, allyl acrylate, hydroxyethyl vinyl ether, hydroxybutyl vinyl ether, maleic acid, and crotonic acid] by a polymeric reaction (for example, the crosslinking reactive group can be introduced by a measure for acting acrylic chloride against a hydroxyl group).

Furthermore, besides the foregoing fluorine-containing monomer unit and the foregoing crosslinking reactive unit, from the viewpoints of solubility in a solvent, transparency of a film and so on, a fluorine atom-free monomer can be properly copolymerized, thereby introducing other polymerization unit. The monomer unit which can be used together is not particularly limited, and examples thereof include olefins (for example, ethylene, propylene, isoprene, vinyl chloride, and vinylidene chloride), acrylic esters (for example, methyl acrylate, methyl acrylate, ethyl acrylate, and 2-ethylhexyl acrylate), methacrylic esters (for example, methyl methacrylate, ethyl methacrylate, butyl methacrylate, and ethylene glycol dimethacrylate), styrene derivatives (for example, styrene, divinylbenzene, vinyltoluene, and α-methylstyrene), vinyl ethers (for example, methyl vinyl ether, ethyl vinyl ether, and cyclohexyl vinyl ether), vinyl esters (for example, vinyl acetate, vinyl propionate, and vinyl cinnamate), acrylamides (for example, N-tert-butyl acrylamide and N-cyclohexyl acrylamide), methacrylamides, and acrylonitrile derivatives.

The foregoing fluorine-containing polymer may be properly used together with a hardening agent as described in JP-A-10-25388 and JP-A-2000-10-147739.

In the invention, an especially useful fluorine-containing polymer is a random copolymer of a perfluoroolefin and a vinyl ether or a vinyl ester. It is especially preferable that the fluorine-containing polymer contains a group which is able to undergo a crosslinking reaction singly [for example, a radical reactive group such as a (meth)acryloyl group and a ring-opening polymerizable group such as an epoxy group and an oxetanyl group].

Such a crosslinking reactive group-containing polymerization unit preferably accounts for from 5 to 70% by mole, and especially preferably from 30 to 60% by mole of the whole of polymerization units of the polymer.

As a preferred embodiment of the fluorine-containing polymer for low refractive index layer which is used in the invention, a copolymer represented by the following formula (1) is enumerated.

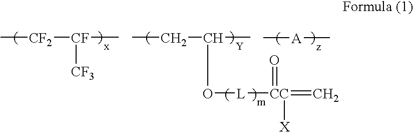

In the formula (1), L represents a connecting group having from 1 to 10 carbon atoms, more preferably a connecting group having from 1 to 6 carbon atoms, and especially preferably a connecting group having from 2 to 4 carbon atoms; may have a linear or branched structure or a cyclic structure; and may contain a hetero atom selected from O, N and S.

Preferred examples thereof include *—(CH₂)₂—O—**, *—(CH₂)₂—NH—**, *—(CH₂)₄—O—**, *—(CH₂)₆—O—**, *—(CH₂)₂—O—(CH₂)₂—O—**, *—CONH—(CH₂)₃—O—**, *—CH₂CH(OH)CH₂—O—**, and *—CH₂CH₂OCONH(CH₂)₃—O—** (* represents a connecting site of the polymer principal chain side; and ** represents a connecting site of the (meth)acryloyl group side). m represents 0 or 1.

In the formula (1), X represents a hydrogen atom or a methyl group; and from the viewpoint of hardening reactivity, X is more preferably a hydrogen atom.

In the formula (1), A represents a repeating unit which is derived from an arbitrary vinyl monomer and is not particularly limited so far as it is a constitutional component of a monomer which is copolymerizable with hexafluoropropylene. A can be properly selected from a variety of viewpoints such as adhesion to a substrate, Tg of a polymer (contributing to the film hardness), solubility in a solvent, transparency, slipperiness, and dustproof or antifouling properties and may be constituted of a single vinyl monomer or plural vinyl monomers according to the purpose.

Preferred examples thereof include vinyl ethers such as methyl vinyl ether, ethyl vinyl ether, t-butyl vinyl ether, cyclohexyl vinyl ether, isopropyl vinyl ether, hydroxyethyl vinyl ether, hydroxybutyl vinyl ether, glycidyl vinyl ether, and allyl vinyl ether; vinyl esters such as vinyl acetate, vinyl propionate, and vinyl butyrate; (meth)acrylates such as methyl (meth)acrylate, ethyl (meth)acrylate, hydroxyethyl (meth)acrylate, glycidyl methacrylate, allyl (meth)acrylate, and (meth)acryloyloxypropyl trimethoxysilane; styrene derivatives such as styrene and p-hydroxymethylstyrene; and unsaturated carboxylic acids such as crotonic acid, maleic acid, and itaconic acid, and derivatives thereof. Of these, vinyl ether derivatives and vinyl ester derivatives are more preferable; and vinyl ether derivatives are especially preferable. x, y and z represent % by mole of the respective constitutional components and represent values which are satisfied with the relations of (30≦x≦60), (5≦y≦70) and (0≦z≦65), more preferably the relations of (35≦x≦55), (30≦y≦60) and (0≦z≦20), and especially preferably the relations of (40≦x≦55), (40≦y≦55) and (0≦z≦10), respectively. However, (x+y+z) is 100.

As an especially preferred embodiment of the copolymer which is used in the invention, the following formula (2) is enumerated.

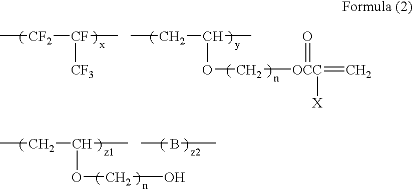

In the formula (2), X has the same meaning as in the formula (1), and a preferred range thereof is also the same.

n represents an integer of (2≦n≦10), preferably (2≦n≦6), and especially preferably (2≦n≦4).

B represents a repeating unit which is derived from an arbitrary vinyl monomer and may be constituted of a single composition or plural compositions. As examples thereof, those as enumerated for A in the foregoing formula (1) are applicable.

x, y, z1 and Z2 represent % by mole of the respective repeating units, respectively. x and y are preferably satisfied with (30≦x≦60) and (5≦y≦70), more preferably (35≦x≦55) and (30≦y≦60), and especially preferably (40≦x≦55) and (40≦y≦55), respectively. z1 and z2 are preferably satisfied with (0≦z1≦65) and (0≦z2≦65), more preferably (0≦z1≦30) and (0≦z2≦10), and especially preferably (0≦z1≦10) and (0≦z2≦5), respectively. However, (x+y+z1+z2) is 100.

The copolymer represented by the formula (1) or (2) can be, for example, synthesized by introducing a (meth)acryloyl group into a copolymer containing a hexafluoropropylene component and a hydroxyalkyl vinyl ether component by any one of the foregoing measures. As a reprecipitation solvent which is used on this occasion, isopropanol, hexane, methanol, and so on are preferable.

As preferred specific examples of the copolymer represented by the formula (1) or (2), ones as described in paragraphs [0035] to [0047] of JP-A-2004-45462 can be enumerated and can be synthesized by a method as described in JP-A-2004-45462.

[Organosilane Compound]

In the light scattering layer or the low refractive index layer of the invention, by containing at least any one of an organosilane compound, a hydrolyzate of an organosilane compound and its partial condensate (a so-called sol component) in a coating solution for forming that layer, the scar resistance is improved. In particular, it becomes possible to make both antireflection performance and scar resistance compatible with each other in the low refractive index layer and its adjacent layers. After coating the coating solution, this sol component is condensed in drying and heating steps to form a hardened material, whereby it becomes a part of the binder of the foregoing layers. Furthermore, in the case where the subject hardened material contains a polymerizable unsaturated bond, a binder having a three-dimensional structure is formed upon irradiation with active rays.

The organosilane compound is preferably one represented by the following formula (A).
(R¹)ₘ—Si(X)₄₋ₘ Formula (A)

In the foregoing formula (A), R¹ represents a substituted or unsubstituted alkyl group or a substituted or unsubstituted aryl group. The alkyl group preferably has from 1 to 30 carbon atoms, more preferably from 1 to 16 carbon atoms, and especially preferably from 1 to 6 carbon atoms. Examples of the alkyl group include methyl, ethyl, propyl, isopropyl, hexyl, decyl, and hexadecyl. Examples of the aryl group include phenyl and naphthyl, with a phenyl group being preferable.

X represents a hydroxyl group or a hydrolyzable group. Examples of the hydrolyzable group include an alkoxy group (preferably an alkoxy group having from 1 to 5 carbon atoms, for example, a methoxy group and an ethoxy group), a halogen atom (for example, Cl, Br, and I), and R²COO (wherein R² is preferably a hydrogen atom or an alkyl group having from 1 to 6 carbon atoms; and examples thereof include CH₃COO and C₂H₅COO). Of these, an alkoxy group is preferable; and a methoxy group and an ethoxy group are especially preferable. m represents an integer of from 1 to 3, and preferably from 1 to 2.

When plural Xs are present, the plural Xs may be the same or different.

The substituent which is contained in R¹ is not particularly limited, and examples thereof include a halogen atom (for example, fluorine, chlorine, and bromine), a hydroxyl group, a mercapto group, a carboxyl group, an epoxy group, an alkyl group (for example, methyl, ethyl, isopropyl, propyl, and t-butyl), an aryl group (for example, phenyl and naphthyl), an aromatic heterocyclic group (for example, furyl, pyrazolyl, and pyridyl), an alkoxy group (for example, methoxy, ethoxy, isopropoxy, and hexyloxy), an aryloxy group (for example, phenoxy), an alkylthio group (for example, methylthio and ethylthio), an arylthio group (for example, phenylthio), an alkenyl group (for example, vinyl and 1-propenyl), an acyloxy group (for example, acetoxy, acryloyloxy, and methacryloyloxy), an alkoxycarbonyl group (for example, methoxycarbonyl and ethoxycarbonyl), an aryloxycarbonyl group (for example, phenoxycarbonyl), a carbamoyl group (for example, carbamoyl, N-methylcarbamoyl, N,N-dimethylcarbamoyl, and N-methyl-N-octylcarbamoyl), and an acylamino group (for example, acetylamino, benzoylamino, acrylamino, and methacrylamino). Such a substituent may be further substituted.

R¹ is preferably a substituted alkyl group or a substituted aryl group. Of the organosilane compounds, a vinyl polymerizable substituent-containing organosilane compound represented by the following formula (B) is preferable.

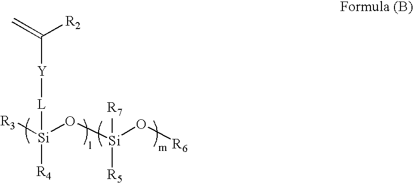

In the foregoing formula (B), R₂ represents a hydrogen atom, a methyl group, a methoxy group, an alkoxycarbonyl group, a cyano group, a fluorine atom, or a chlorine atom. Examples of the alkoxycarbonyl group include a methoxycarbonyl group and an ethoxycarbonyl group. Above all, a hydrogen atom, a methyl group, a methoxy group, a methoxycarbonyl group, a cyano group, a fluorine atom, and a chlorine atom are preferable; a hydrogen atom, a methyl group, a methoxycarbonyl group, a fluorine atom, and a chlorine atom are more preferable; and a hydrogen atom and a methyl group are especially preferable.

Y represents a single bond, *—COO—**, *—CONH—**, or *—O—**. Of these, a single bond, *—COO—**, and *—CONH—** are preferable; a single bond and *—COO—** are more preferable; and *—COO—** is especially preferable. * represents the binding position to ═C(R₂); and ** represents the binding position to L.

L represents a divalent connecting chain. Specific examples thereof include a substituted or unsubstituted alkylene group, a substituted or unsubstituted arylene group, a substituted or unsubstituted alkylene group containing a connecting group (for example, ethers, esters, and amides) therein, and a substituted or unsubstituted arylene group containing a connecting group therein. Of these, a substituted or unsubstituted alkylene group, a substituted or unsubstituted arylene group, and an alkylene group containing a connecting group therein are preferable; an unsubstituted alkylene group, an unsubstituted arylene group, and an alkylene group containing an ether or ester connecting group therein are more preferable; and an unsubstituted alkylene group and an alkylene group containing an ether or ester connecting group therein are especially preferable. Examples of the substituent include a halogen, a hydroxyl group, a mercapto group, a carboxyl group, an epoxy group, an alkyl group, and an aryl group. Such a substituent may be further substituted.

1 and m each represents a molar fraction which is satisfied with a numerical expression: [1=(100−m)]; and m represents a number of from 0 to 50. m is more preferably a number of from 0 to 40, and especially preferably a number of from 0 to 30.

R₃ to R₅ are each preferably a chlorine atom, a hydroxyl group, an unsubstituted alkyl group, or an unsubstituted alkoxy group; more preferably a hydroxyl group or an alkoxy group having from 1 to 6 carbon atoms; and especially preferably a hydroxyl group or an alkoxy group having from 1 to 3 carbon atoms. R₆ represents a hydrogen atom or an alkyl group. The alkyl group is preferably a methyl group or an ethyl group.

R₇ represents a substituted or unsubstituted alkyl group, a substituted or unsubstituted aryl group, or a hydroxyl group; and preferably an alkyl group having from 1 to 3 carbon atoms or a hydroxyl group.

Specific examples of a starting material of the compound represented by the formula (B) will be given below, but it should not be construed that the invention is limited thereto.

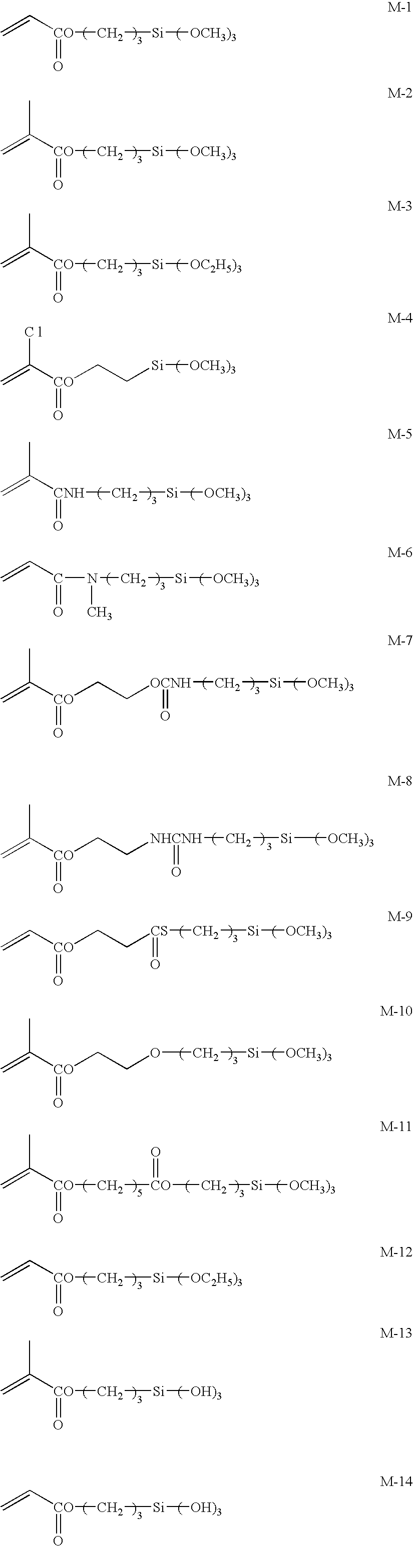

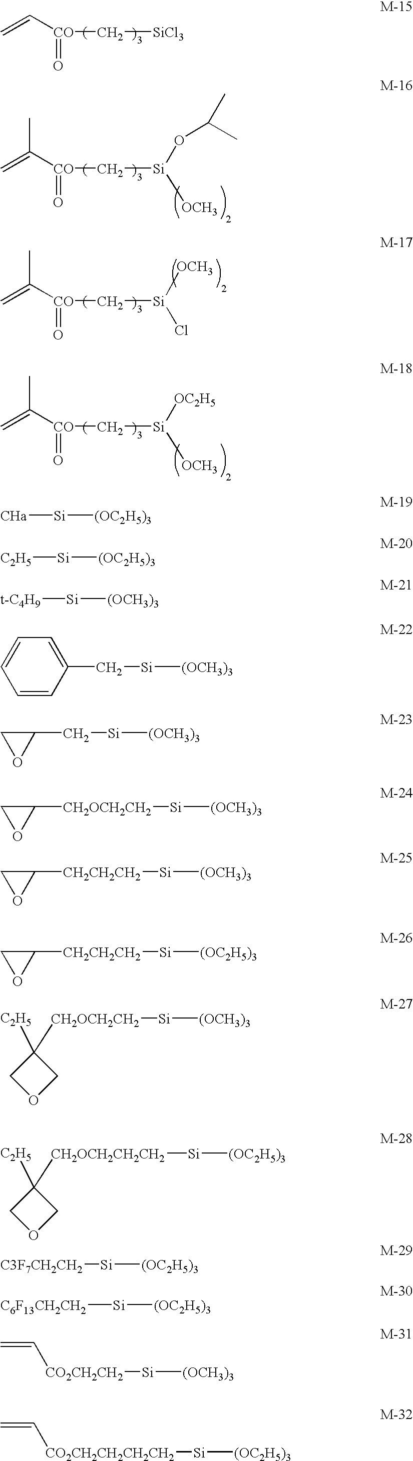

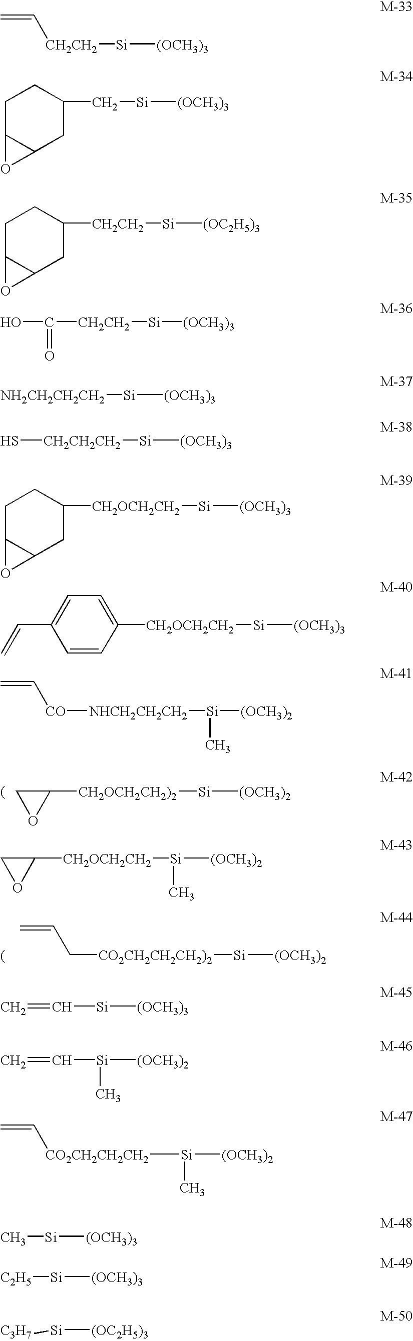

Of these, combinations of organosilanes selected from (M-1), (M-2) (M-25) and (M-19), (M-48) and (M-49), respectively are especially preferable.

In order to obtain the effects of the invention, the content of the vinyl polymerizable group-containing organosilane in the hydrolyzate of an organosilane and/or its partial condensate is preferably from 30% by weight to 100% by weight, more preferably from 50% by weight to 100% by weight, further preferably from 70% by weight to 100% by weight, and especially preferably from 90% by weight to 100% by weight. When the content of the vinyl polymerizable group-containing organosilane is less than 30% by weight, a solid is generated; the liquid becomes cloudy; a pot life is deteriorated; the control of the molecular weight becomes difficult (the molecular weight increases); and when a polymerization treatment is carried out, an improvement of a performance (for example, scar resistance of the antireflection film) is hardly obtained because of a low content of the polymerizable group. Therefore, such is not preferable.

For the purpose of stabilizing the performance of a coated article, it is preferable that the volatility of at least any one of the hydrolyzate of an organosilane and its partial condensate according to the invention is suppressed. Concretely, the amount of volatilization per hour at 105° C. is preferably not more than 5% by weight, more preferably not more than 3% by weight, and especially preferably not more than 1% by weight.

The sol component which is used in the invention is prepared by hydrolyzing and/or partially condensing the foregoing organosilane.

The hydrolysis condensation reaction is carried out by adding water in an amount of from 0.05 to 2.0 moles, and preferably from 0.1 to 1.0 mole per mole of the hydrolyzable group (X) and stirring at from 25 to 100° C. in the presence of the catalyst which is used in the invention.

In at least any one of the hydrolyzate of an organosilane and its partial condensate according to the invention, a weight average molecular weight of either one of the hydrolyzate of the vinyl polymerizable group-containing organosilane or its partial condensate from which, however, components having a molecular weight of less than 300 are excluded is preferably from 450 to 20,000, more preferably from 500 to 10,000, further preferably from 550 to 5,000, and still further preferably from 600 to 3,000.

Among the components having a molecular weight of 300 or more in the hydrolyzate of an organosilane and/or its partial condensate, the content of a component having a molecular weight exceeding 20,000 is preferably not more than 10% by weight, more preferably not more than 5% by weight, and further preferably 3% by weight. When the content of a component having a molecular weight exceeding 20,000 is more than 10% by weight, there is a possibility that a hardened film obtainable by hardening a hardenable composition containing such a hydrolyzate of an organosilane and/or its partial condensate is deteriorated in transparency or adhesion to a substrate.

Here, the weight average molecular weight and the number average molecular weight are a molecular weight as reduced into polystyrene, which is detected in THF as a solvent by a differential refractometer by using a GPC analyzer with a column of “TSKgel GMHxL”, “TSKgel G4000HxL” or “TSKgel G2000HxL” (all of which are a trade name as manufactured by Tosoh Corporation). In the case where a peak area of components having a molecular weight of 300 or more is defined as 100%, the content means an area % of peaks of the foregoing molecular weight range.

A degree of dispersion [(weight average molecular weight)/(number average molecular weight)] is preferably from 3.0 to 1.1, more preferably from 2.5 to 1. 1, further preferably from 2.0 to 1. 1, and especially preferably from 1.5 to 1.1.

By the ²⁹Si-NMR analysis of the hydrolyzate of an organosilane and its partial condensate according to the invention, a state that X of the formula (A) is condensed in an —OSi form can be confirmed.

At this time, in the case where three bonds of Si are condensed in an —OSi form (T3), the case where two bonds of Si are condensed in an —OSi form (T2), the case where one bond of Si is condensed in an —OSi form (T1), and the case where Si is not condensed at all (T0), a condensation rate α which is expressed by the following expression (II):
α=(T3×3+T2×2+T1×1)/3/(T3+T2+T1+T0) Numerical Expression (II)
is preferably from 0.2 to 0.95, more preferably from 0.3 to 0.93, and especially preferably from 0.4 to 0.9.

When the condensation rate α is less than 0.2, the hydrolysis or condensation is not sufficient and the amount of the monomer components increases so that the hardening does not proceed sufficiently. On the other hand, when the condensation rate α is larger than 0.95, the hydrolysis or condensation excessively proceeds and the hydrolyzable group is consumed so that a mutual action among the binder polymer, the resin substrate, the inorganic fine particle, and so on is lowered. As a result, even by using these materials, the desired effects are hardly obtained.

The hydrolyzate of an organosilane compound and its partial condensate which are used in the invention will be hereunder described in detail.

The hydrolysis reaction of the organosilane and the subsequent condensation reaction are generally carried out in the presence of a catalyst. Examples of the catalyst include inorganic acids such as hydrochloric acid, sulfuric acid, and nitric acid; organic acids such as oxalic acid, acetic acid, butyric acid, maleic acid, citric acid, formic acid, methanesulfonic acid, and toluenesulfonic acid; inorganic bases such as sodium hydroxide, potassium hydroxide, and ammonia; organic bases such as triethylamine and pyridine; metal alkoxides such as triisopropoxy aluminum, tetrabutoxy zirconium, tetrabutyl titanate, and dibutyltin dilaurate; metal chelate compounds containing, as a central metal, a metal (for example, Zr, Ti, and Al); and fluorine-containing compound such as KF and NH₄F.

The foregoing catalyst may be used singly or in combination of plural kinds thereof.

Though the hydrolysis reaction and condensation reaction of the organosilane may be carried out in the absence of a solvent or in a solvent, for the purpose of uniformly mixing the components, it is preferred to use an organic solvent. Examples of the solvent include alcohols, aromatic hydrocarbons, ethers, ketones, and esters.

The solvent is preferably a solvent capable of dissolving the organosilane and the catalyst therein. From the process standpoint, it is preferred to use an organic solvent as a coating solution or a part of a coating solution. The solvent is preferably a solvent which in the case of mixing with other raw materials such as the fluorine-containing polymer, does not impair solubility or dispersibility.

Of these, examples of the alcohol include monohydric alcohols and dihydric alcohols. As the monohydric alcohol, saturated aliphatic alcohols having from 1 to 8 carbon atoms are preferable.

Specific examples of such an alcohol include methanol, ethanol, n-propyl alcohol, isopropyl alcohol, n-butyl alcohol, sec-butyl alcohol, tert-butyl alcohol, ethylene glycol, diethylene glycol, triethylene glycol, ethylene glycol monobutyl ether, and acetic acid ethylene glycol monoethyl ether.

Furthermore, specific examples of the aromatic hydrocarbon include benzene, toluene and xylene; specific example of the ether include tetrahydrofuran and dioxane; specific examples of the ketone include acetone, methyl ethyl ketone, methyl isobutyl ketone, diisobutyl ketone, and cyclohexanone; and specific examples of the ester include ethyl acetate, propyl acetate, butyl acetate, and propylene carbonate.

Such an organic solvent can be used singly or in admixture of two or more kinds thereof. Though the concentration of the solid in the subject reaction is not particularly limited, it is usually in the range of from 1% to 100%.

The reaction is carried out by adding water in an amount of from 0.05 to 2 moles, and preferably from 0.1 to 1 mole per mole of the hydrolyzable group of the organosilane and stirring the mixture in the presence or absence of the foregoing solvent and in the presence of the catalyst at from 25 to 100° C.

In the invention, it is preferable that the hydrolysis is carried out by stirring the mixture in the presence of at least one metal chelate compound containing, as ligands, an alcohol represented by the formula: R⁸OH (wherein R⁸ represents an alkyl group having from 1 to 10 carbon atoms) and a compound represented by the formula: R⁹COCH₂COR¹⁰ (wherein R⁹ represents an alkyl group having from 1 to 10 carbon atoms; and R¹⁰ represents an alkyl group having from 1 to 10 carbon atoms or an alkoxy group having from 1 to 10 carbon atoms) and containing, as a central metal, a metal selected from Zr, Ti and Al at from 25 to 100° C.

Alternatively, in the case of using a compound containing F as the catalyst, since the F-containing compound has an ability to advance the hydrolysis and condensation, by selecting the amount of water to be added, a polymerization degree can be determined so that it becomes possible to set up an arbitrary molecular weight. Therefore, such is preferable. That is, in order to prepare an organosilane hydrolyzate/partial condensate having an average polymerization degree M, (M−1) moles of water may be used against M moles of a hydrolyzable organosilane.

So far as the metal chelate compound is a metal chelate compound containing, as ligands, an alcohol represented by the formula: R⁸OH (wherein R⁸ represents an alkyl group having from 1 to 1 0 carbon atoms) and a compound represented by the formula: R⁹COCH₂COR¹⁰ (wherein R⁹ represents an alkyl group having from 1 to 10 carbon atoms; and R¹⁰ represents an alkyl group having from 1 to 10 carbon atoms or an alkoxy group having from 1 to 10 carbon atoms) and containing, as a central metal, a metal selected from Zr, Ti and Al, it can be suitably used without particular limitations. Two or more kinds of the metal chelate compound may be used jointly within the foregoing scope. The metal chelate compound which is used in the invention is preferably selected from a group of compounds represented by the formulae: Zr(OR⁸)ₚ₁(R⁹COCHCOR¹⁰)ₚ₂, Ti(OR⁸)_{q1}(R⁹COCHCOR¹⁰)_{q2}, and Al(OR⁸)ᵣ₁(R⁹COCHCOR¹⁰)ᵣ₂ and has an action to promote the condensation reaction of the hydrolyzate of an organosilane compound and its partial condensation.

In the metal chelate compound, R⁸ and R⁹ may be the same or different and each represents an alkyl group having from 1 to 10 carbon atoms (for example, an ethyl group, an n-propyl group, an isopropyl group, an n-butyl group, a sec-butyl group, a t-butyl group, and an n-pentyl group). Furthermore, R¹⁰ represents an alkyl group having from 1 to 10 carbon atoms (the same as the foregoing alkyl group) or an alkoxy group having from I to 10 carbon atoms (for example, a methoxy group, an ethoxy group, an n-propoxy group, an isopropoxy group, an n-butoxy group, a sec-butoxy group, and a t-butoxy group). Furthermore, in the metal chelate compound, p1, p2, ql, q2, r1 and r2 each represents an integer as determined such that (p1+p2) is 4, (q1+q2) is 4, and (r1+r2) is 3.

Specific examples of such a metal chelate compound include zirconium chelate compounds such as tri-n-butoxyethyl acetoacetate zirconium, di-n-butoxy bis(ethyl acetoacetate) zirconium, n-butoxy tris(ethyl acetoacetate) zirconium, tetrakis(n-propyl acetoacetate) zirconium, tetrakis(acetyl acetoacetate) zirconium, and tetrakis(ethyl acetoacetate) zirconium; titanium chelate compounds such as diisopropoxy.bis(ethyl acetoacetate) titanium, diisopropoxy.bis(acetyl acetate) titanium, and diisopropoxy.bis(acetytlacetone) titanium; and aluminum chelate compounds such as diisopropoxyethyl acetoacetate aluminum, diisopropoxyacetyl acetonate aluminum, isopropxy bis(ethyl acetoacetate) aluminum, isopropoxy bis(acetyl acetonate) aluminum, tris(ethyl acetoacetate) aluminum, tris(acetyl acetonate) aluminum, and monoacetyl acetonate.bis(ethyl acetoacetate) aluminum.

Of these metal chelate compounds, tri-n-butoxyethyl acetoacetate zirconium, diisopropoxy.bis(acetyl acetate) titanium, diisopropoxyethyl acetoacetate aluminum, and tris(ethyl acetoacetate) aluminum are preferable. Such a metal chelate compound can be used singly or in admixture of two or more kinds thereof. A partial hydrolyzate of such a metal chelate compound can also be used.

The metal chelate compound is preferably used in a proportion of from 0.01 to 50% by weight, more preferably from 0.1 to 50% by weight, and further preferably from 0.5 to 10% by weight based on the foregoing organosilane compound. By using the metal chelate compound within the foregoing range, the condensation reaction of the organosilane compound is fast; the durability of a coating film is satisfactory; and the storage stability of a composition containing the hydrolyzate of an organosilane compound and its partial condensate and the metal chelate compound is satisfactory.

It is preferable that in addition to the composition containing the foregoing sol component and metal chelate compound, at least any one of a β-diketone compound and a β-ketoester compound is added in the coating solution of a low refractive index layer or other layer which is used in the invention. This will be further described below.

The compound which is used in the invention is at least any one of a β-diketone compound and a β-ketoester compound represented by the formula: R⁹COCH₂COR¹⁰ and acts as a stability improving agent of the composition to be used in the invention. That is, it is thought that by coordinating in a metal atom in the foregoing metal chelate compound (at least any one compound of zirconium, titanium and aluminum compounds), an action to promote the condensation reaction of the hydrolyzate of an organosilane compound and its partial condensate due to such a metal chelating compound is suppressed, thereby acting to improve the storage stability of the resulting composition. R⁹ and R¹⁰ constituting the β-diketone compound or the β-ketoester compound are synonymous with R⁹ and R¹⁰ constituting the foregoing metal chelate compound.

Specific examples of the β-diketone compound and the β-ketoester compound include acetylacetone, methyl acetoacetate, ethyl acetoacetate, n-propyl acetoacetate, isopropyl acetoacetate, n-butyl acetoacetate, sec-butyl acetoacetate, t-butyl acetoacetate, 2,4-hexanedione, 2,4-heptanedione, 3,5-heptanedione, 2,4-octanedione, 2,4-nonanedione, and 5-methylhexanedione. Of these, ethyl acetoacetate and acetylacetone are preferable, with acetylacetone being especially preferable. Such a β-diketone compound or β-ketoester compound can be used singly or in admixture of two or more kinds thereof. In the invention, the β-diketone compound or β-ketoester compound is preferably used in an amount of 2 moles or more, and more preferably from 3 to 20 moles per mole of the metal chelate compound. When the amount of the β-diketone compound or β-ketoester compound is less than 2 moles, the resulting composition may possibly be deteriorated in storage stability and therefore, such is not preferred.

It is preferable that in the case of a low refractive index layer which is a relatively thin film, the content of the hydrolyzate of an organosilane compound and its partial condensate is low, whereas in the case of a functional layer which is a thick film, it is high. Taking into consideration revealment of the effects, refractive index, shape and surface properties of the film, and so on, the content of the hydrolyzate of an organosilane compound and its partial condensate is preferably from 0.1 to 50% by weight, more preferably from 0.5 to 30% by weight, and most preferably from 1 to 15% by weight based on the whole of solids in the layer in which the hydrolyzate of an organosilane compound and its partial condensate are contained (the layer in which the hydrolyzate of an organosilane compound and its partial condensate are added).

[Ionizing Radiation Hardenable Polyfunctional Monomer]

The coating composition (coating solution) for forming a low refractive index layer according to the invention can contain an ionizing radiation hardenable polyfunctional monomer. When the coating composition is coated, dried and then irradiated with ionizing radiations, the subject monomer causes chemical binding to form a coating film. The ionizing radiation hardenable monomer is a monomer which is hardened due to a chemical reaction such as polymerization, addition polymerization, and polycondensation by ionizing radiations. Monomers containing, for example, an acrylic group, a vinyl group or an epoxy group are easily available and preferable.

It is also preferable that such a monomer contains a thermally hardenable group; and it is also preferable that the monomer contains, for example, a hydroxyl group, an alkoxy group, a carboxyl group, an amino group, an epoxy group, or an isocyanate group.

The functional group of the ionizing radiation hardenable polyfunctional monomer is preferably bifunctional or polyfunctional, and especially preferably trifunctional or polyfunctional. Specific examples of such an ionizing radiation hardenable polyfunctional monomer include ones as described in a section of “Antiglare hard coat layer” as described later.

Specific examples of the ionizing radiation hardenable polyfunctional monomer include esters of a polyhydric alcohol and (meth)acrylic acid (for example, ethylene glycol di(meth)acrylate, 1,4-cyclohexane diacrylate, pentaerythritol tetra(meth)acrylate, pentaerythritol tri(meth)acrylate, trimethylolpropane tri(meth)acrylate, trimethylolethane tri(meth)acrylate, dipentaerythritol tetra(meth)acrylate, dipentaerythritol penta(meth)acrylate, dipentaerythritol hexa(meth)acrylate, 1,2,3-cyclohexane tetramethacrylate, polyurethane polyacrylate, and polyester polyarylates), vinylbenzene and derivatives thereof (for example, 1,4-divinylbenzene, 2-acryloylethyl 4-vinylbenzoate, and 1,4-divinylcyclohexanone), vinylsulfones (for example, divinylsulfone), acrylamides (for example, methylenebisacrylamide), and methacrylamides. Two or more kinds of such a monomer may be used together.

The amount of addition of the ionizing radiation hardenable polyfunctional monomer in the coating composition is generally from 0.01 to 10% by weight, and preferably from 0.1 to 5% by weight.

[Inorganic Fine Particle having Voids]

For the purpose of lowering the refractive index, it is preferable that the low refractive index layer according to the invention contains an inorganic fine particle having voids in the inside thereof. The voids are preferably porous or hollow, and the inorganic fine particle may be a fine particle having a structure in which inorganic fine particles are connected to each other in a chain-like state to form voids. Above all, an inorganic fine particle having a hollow structure is especially preferable.

The hollow inorganic fine particle is preferably silica having a hollow structure. The hollow silica fine particle preferably has a refractive index of from 1.17 to 1.40, more preferably from 1.17 to 1.35, and most preferably from 1.17 to 1.30. The refractive index as referred to herein expresses a refractive index as the whole of the particle but does not express a refractive index of only silica in an outer shell which forms the hollow silica fine particle. At this time, when a radius of the void within the particle is defined as “a” and a radius of the outer shell of the particle is defined as “b”, a porosity x which is calculated according to the following numerical expression (III) is preferably from 10 to 60%, more preferably from 20 to 60%, and most preferably from 30 to 60%.
x=(4πa³/3)/(4πb³/3)×100 Numerical Expression (III)

When it is intended to make the hollow silica particle have a lower refractive index and a larger porosity, the thickness of the outer shell becomes thin so that the strength as the particle is weakened. Accordingly, a particle having a low refractive index of less than 1.17 is not applicable from the viewpoint of scar resistance.

Incidentally, the refractive index of such a hollow silica particle was measured by an Abbe's refractometer (manufactured by Atago Co., Ltd.).

Furthermore, a manufacturing method of the hollow silica is described in, for example, JP-A-2001-233611 and JP-A-2002-79616.

The blending amount of the hollow silica is preferably from 1 mg/m² to 100 mg/m², more preferably from 5 mg/m² to 80 mg/m², and further preferably from 10 mg/m² to 60 mg/m². When the blending amount of the hollow silica falls within the foregoing range, the scar resistance is excellent, fine irregularities on the surface of the low refractive index layer are reduced, and the appearance including firmness of black color and the integrated reflectance are improved.

With respect to the average particle size of the hollow silica, the thickness of the low refractive index layer is preferably 30% or more and not more than 150%, more preferably 35% or more and not more than 80%, and further preferably 40% or more and not more than 60%. That is, when the thickness of the low refractive index layer is 100 nm, the particle size of the hollow silica is preferably 30 nm or more and not more than 150 nm, more preferably 35 nm or more and not more than 80 nm, and further preferably 40 nm or more and not more than 60 nm.

When the particle size of the silica fine particle falls within the foregoing range, the refractive index is lowered, fine irregularities on the surface of the low refractive index layer are reduced, and the appearance including firmness of black color and the integrated reflectance are improved. Though the silica fine particle may be either crystalline or amorphous, it is preferably a monodispersed particle. Though the shape of the silica fine particle is most preferably a spherical shape, there is no problem even when it is amorphous.

Here, the average particle size of the hollow silica can be determined from an electron microscopic photograph.

In the invention, it is possible to use a void-free silica particle together with the hollow silica particle. The void-free silica preferably has a particle size of 30 nm or more and not more than 150 nm, more preferably 35 nm or more and not more than 80 nm, and most preferably 40 nm or more and not more than 60 nm.

Furthermore, it is also possible to use at least one silica fine particle having an average particle size of less than 25% of the thickness of the low refractive index layer (referred to as “small particle-sized silica fine particle”) together with the silica fine particle having the foregoing particle size (referred to as “large particle-sized silica fine particle”).

Since the small particle-sized silica fine particle can exist in a gap between the large particle-sized silica fine particles, it can contribute as a holding agent of the large particle-sized silica fine particle.

The average particle size of the small particle-sized silica fine particle is preferably 1 nm or more and not more than 20 nm, more preferably 5 nm or more and not more than 15 nm, and especially preferably 10 nm or more and not more than 15 nm. The use of such a silica fine particle is preferable from the standpoints of raw material costs and an effect of the holding agent.

In order to design to achieve dispersion stability in the dispersion or coating solution or to enhance the compatibility and binding properties with the binder component, the silica fine particle may be subjected to a physical surface treatment such as a plasma discharge treatment and a corona discharge treatment or a chemical surface treatment with a surfactant, a coupling agent, or the like. Of these, the use of a coupling agent is especially preferable. Alkoxy metal compounds (for example, titanium coupling agents and silane coupling agents) are preferably used as the coupling agent. Above all, a treatment with a silane coupling agent containing an acryloyl group or a methacryloyl group is especially effective.

Though the foregoing coupling agent is used for undergoing a surface treatment in advance prior to the preparation of a coating solution for the subject layer as a surface treating agent of the inorganic fine particle of the low refractive index layer, it is preferred to contain the coupling agent in the subject layer by further adding it as an additive at the time of preparation of the coating solution for the subject layer.

For the purpose of reducing a load of the surface treatment, it is preferable that the silica fine particle is dispersed in advance in a medium prior to the surface treatment.

[Fluorine and/or Silicone Based Compound]

It is preferable that the low refractive index layer according to the invention contains a fluorine and/or silicone based compound. By using such a compound, it is possible to lower the surface free energy, thereby improving antifouling properties, slipperiness, waterproof properties, and so on.

As such a compound, known silicone based compounds or fluorine based compounds can be used. In the case of adding such a compound, the compound is preferably added in an amount in the range of from 0.01 to 20% by weight, more preferably from 0.05 to 10% by weight, and especially preferably from 0.1 to 5% by weight of the whole of solids of the low refractive index layer.

Preferred examples of the silicone based compound include compounds containing plural dimethylsilyloxy units as a repeating unit and containing a substituent in a terminal and/or a side chain of the chemical chain thereof. Furthermore, a structural unit other than dimethylsilyloxy may be contained in the chemical chain containing the dimethylsilyloxy as a repeating unit. The substituent may be the same or different, and it is preferable that plural substituents are contained. Preferred examples of the substituent include groups containing, for example, an acryloyl group, a methacryloyl group, a vinyl group, an aryl group, a cinnamoyl group, an epoxy group, an oxetanyl group, a hydroxyl group, a fluoroalkyl group, a polyoxyalkylene group, a carboxyl group, or an amino group. Though the molecular weight is not particularly limited, it is preferably not more than 100,000, more preferably not more than 50,000, especially preferably from 3,000 to 30,000, and most preferably from 10,000 to 20,000. Though the content of a silicon atom of the silicone based compound is not particularly limited, it is preferably 18.0% by weight or more, especially preferably from 25.0 to 37.8% by weight, and most preferably from 30.0 to 37.0% by weight. Preferred examples of the silicone based compound include X-22-174DX, X-22-2426, X-22-164B, X22-164C, X-22-170DX, X-22-176D, X-22-1821 and FL100 (all of which are a trade name, manufactured by Shin-Etsu Chemical Co., Ltd.); FM-0725, FM-7725, FM-4421, FM-5521, FM-6621 and FM-1121 (all of which are manufactured by Chisso Corporation); DMS-U22, RMS-033, RMS-083, UMS-182, DMS-H21, DMS-H31, HMS-301, FMS121, FMS123, FMS131, FMS141 and FMS221 (all of which are a trade name, manufactured by Gelest, Inc.); and TSF4460 (manufactured by GE Toshiba Silicone Co., Ltd.). However, it should not be construed that the invention is limited thereto.

As the fluorine based compound, compounds containing a fluoroalkyl group are preferable. The subject fluoroalkyl group preferably has from 1 to 20 carbon atoms, and more preferably from 1 to 10 carbon atoms. The fluoroalkyl group may be of a linear structure (for example, —CF₂CF₃, —CH₂(CF₂)₄H, —CH₂(CF₂)₈CF₃, and —CH₂CH₂(CF₂)₄H), a branched structure (for example, CH(CF₃)₂, CH₂CF(CF₃)₂, CH(CH₃)CF₂CF₃, and CH(CH₃)(CF₂)₅CF₂H), or an alicyclic structure (preferably a 5-membered ring or a 6-membered ring; for example, a perfluorocyclohexyl group, a perfluorocyclopentyl group, and an alkyl group substituted with the preceding group); and may contain an ether bond (for example, CH₂OCH₂CF₂CF₃, CH₂CH₂OCH₂C₄F₈H, CH₂CH₂OCH₂CH₂C₈F₁₇, and CH₂CH₂OCF₂CF₂OCF₂CF₂H). A plural number of the subject fluoroalkyl group may be contained in the same molecule.

It is preferable that such a fluorine based compound further contains a substituent which contributes to the formation of binding to a low refractive index layer film or compatibility therewith. The subject substituent may be the same or different, and it is preferable that plural substituents are contained. Preferred examples of the substituent include an acryloyl group, a methacryloyl group, a vinyl group, an aryl group, a cinnamoyl group, an epoxy group, an oxetanyl group, a hydroxyl group, a polyoxyalkylene group, a carboxyl group, and an amino group. The fluorine based compound may be a polymer or oligomer with a fluorine atom-free compound. Its molecular weight is not particularly limited. Though the content of a fluorine atom of the fluorine based compound is not particularly limited, it is preferably 20% by weight or more, especially preferably from 30 to 70% by weight, and most preferably from 40 to 70% by weight. Preferred examples of the fluorine based compound include R-2020, M-2020, R-3833, and M-3833 (all of which are a trade name, manufactured by Daikin Industries, Ltd.); MEGAFAC F-171, MEGAFAC F-172, MEGAFAC F-179A, and DEFENSA MCF-300 (all of which are a trade name, manufactured by Dainippon Ink and Chemical, Incorporated); and MODIPER F Series (manufactured by NOF Corporation). However, it should not be construed that the invention is limited thereto.

It is preferable that the fluorine and/or silicon-containing compound contains at least one group having reactivity with the binder in the molecule thereof. Examples of the preferred reactive group include a thermally hardenable active hydrogen atom, a hydroxyl group, a melamine, an active energy ray hardenable (meth)acryloyl group, and an epoxy group. Of these, a melamine and a (meth)acryloyl group are especially preferable.

For the purpose of inhibiting coagulation or sedimentation of the inorganic fine particle, it is also preferable that a dispersion stabilizer is used jointly in the coating solution for forming each layer. Examples of the dispersion stabilizer which can be used include polyvinyl alcohol, polyvinylpyrrolidone, cellulose derivatives, polyamides, phosphoric esters, polyethers, surfactants, silane coupling agents, and titanium coupling agents. The foregoing silane coupling agents are especially preferable because a film after hardening is strong.

The coating composition for forming a low refractive index layer of the invention takes a liquid form and contains the foregoing organosilane compound and a hydrolyzate thereof and/or its partial condensate and the fluorine-containing polymer and optionally, various additives such as an inorganic fine particle, a fluorine and/or silicone based compound, other binder, and a radical polymerization initiator. This coating composition is prepared by dissolving these components in an appropriate solvent.

On this occasion, though the concentration of solids is properly selected depending upon the application, it is generally from about 0.01 to 60% by weight, preferably from about 0.5 to 50% by weight, and especially preferably from about 1 to 20% by weight.

The thickness of the low refractive index layer after hardening is preferably from 10 to 500 nm, more preferably from 20 to 300 nm, and further preferably from 30 to 200 nm.

Furthermore, from the viewpoint of film hardness of the low refractive index layer, it is not always advantageous to add an additive such as a hardening agent. However, from the viewpoints of interfacial adhesion to a high refractive index layer and so on, a small amount of a hardening agent such as polyisocyanate compounds, aminoplasts, and polybasic acids or anhydrides thereof can be added, too. In the case of using such a hardening agent, it is preferably added in an amount in the range of from 0 to 30% by weight, more preferably from 0 to 20% by weight, and especially preferably from 0 to 10% by weight based on the whole of solids of the low refractive index layer film.

For the purpose of imparting characteristics such as dustproof properties and antistatic properties, dustproof agents or antistatic agents such as known cationic surfactants and polyoxyalkylene based compounds can also be properly added in the low refractive index layer according to the invention. With respect to such a dustproof agent or antistatic agent, its structural unit may be contained as a part of the function in the foregoing silicone based compound or fluorine based compound. When such a dustproof agent or antistatic agent is added as an additive, it is preferably added in an amount ranging from 0.01 to 20% by weight, more preferably from 0.05 to 10% by weight, and especially preferably from 0.1 to 5% by weight of the whole of solids of the low refractive index layer. Preferred examples of the compound include MEGAFAC F-150 (a trade name, manufactured by Dainippon Ink and Chemicals, Incorporated) and SH-3748 (a trade name, manufactured by Dow Corning Toray Co., Ltd.). However, it should not be construed that the invention is limited thereto.

Next, other layers in the optical film of the invention will be described.

[Antistatic Layer]

Examples of a method of forming an antistatic layer include conventionally known methods such as a method of coating a conductive coating solution containing a conductive fine particle and a reactive hardenable resin and a method of forming a conductive thin film by vapor deposition or sputtering of a metal or metal oxide capable of forming a transparent film or the like. The antistatic layer can be formed on a transparent support directly or via a primer layer capable of strengthening bonding to a transparent support. Furthermore, the antistatic layer can be used as a part of the antireflection film. In this case, in the case where the antistatic layer is used in a layer close to the outermost surface layer, even when the film is thin, it is possible to sufficiently obtain antistatic properties.

The antistatic layer preferably has a thickness of from 0.01 to 10 μm, more preferably from 0.03 to 7 μm, and further preferably from 0.05 to 5 μm. The antistatic layer preferably has a surface resistivity value (log SR) at 25° C. and 55% RH of not more than 12 Ω/sq, and more preferably not more than 10 Ω/sq. Furthermore, in order to make it compatible with the transparency of the coating film, the surface resistivity value is preferably 5 Ω/sq or more. That is, the resistivity value at 25° C. and 55% RH is preferably from 5 to 12 Ω/sq, and more preferably from 5 to 10 Ω/sq. The surface resistivity of the antistatic layer can be measured by a four probe method. By making the surface resistivity of the antistatic layer fall within the foregoing range, an optical film which is transparent and satisfactory in dustproof properties is obtained.

Furthermore, it is preferable that the antistatic layer is of an electronic conduction type which is low in changes of the surface resistivity value due to the temperature and humidity of the environment.

It is preferable that the antistatic layer is substantially transparent. Concretely, the haze of the antistatic layer is preferably not more than 10%, more preferably not more than 5%, further preferably not more than 3%, and most preferably not more than 1%. In addition, the antistatic layer preferably has a transmittance of light of 50% or more, more preferably 60% or more, further preferably 65% or more, and most preferably 70% or more.

Moreover, it is preferable that the antistatic layer is excellent in strength. Concretely, the antistatic layer preferably has a strength of H or more, more preferably 2H or more, further preferably 3H or more, and most preferably 4H or more in terms of a pencil hardness under a load of 1 kg (as defined according to JIS-K-5400).

It is preferable that the conductive inorganic fine particle which is contained in the antistatic layer is formed of a metal oxide or nitride. Examples of the metal oxide or nitride include tin oxide, indium oxide, zinc oxide, and titanium nitride. Of these, tin oxide and indium oxide are especially preferable. The conductive inorganic fine particle contains, as the major component, such a metal oxide or nitride and can further contain other element. The “major component” as referred to herein means a component having the highest content (% by weight) among the components which constitute the particle. Examples of other element include Ti, Zr, Sn, Sb, Cu, Fe, Mn, Pb, Cd, As, Cr, Hg, Zn, Al, Mg, Si, P, S, B, Nb, In, V, and halogen atoms. For the purpose of enhancing the conductivity of tin oxide and indium oxide, it is preferred to use Sb, P, B, Nb, In, V, or a halogen atom. Tin oxide containing Sb (ATO) and indium oxide containing Sn (ITO) are especially preferable. A proportion of Sb in ATO is preferably from 3 to 20% by weight; and a proportion of Sn in ITO is preferably from 5 to 20% by weight.

In the antistatic layer, a crosslinked polymer can be used as the binder. It is preferable that the subject crosslinked polymer contains an anionic group. In the crosslinked polymer containing an anionic group, the principal chain of the anionic group-containing polymer has a crosslinking structure. The anionic group has a function to keep a dispersed state of the conductive inorganic fine particle. The crosslinking structure has a function to strengthen the antistatic layer by imparting a film forming ability to the polymer.

As the anionic group-containing crosslinking polymer, polymers containing, as the principal chain, a polyolefin (a saturated hydrocarbon), a polyether, a polyurea, a polyurethane, a polyester, a polyamine, a polyamide, etc. and melamine resins are preferable. Above all, a polyolefin principal chain, a polyether principal chain and a polyurea principal chain are preferable; a polyolefin principal chain and a polyether principal chain are more preferable; and a polyolefin principal chain is the most preferable.

[Hard Coat Layer]

With respect to the hard coat layer, for the purpose of imparting a physical strength to the optical film, a so-called smooth hard coat layer which does not have antiglare properties is also preferably used and provided on the surface of the transparent support. In particular, it is preferable that the hard coat layer is provided between the transparent support and the foregoing functional layer (for example, the antistatic layer and the light scattering layer).

It is preferable that the hard coat layer is formed by a crosslinking reaction or polymerization reaction of the ionizing radiation hardenable compound. For example, the hard coat layer can be formed by coating a coating composition containing an ionizing radiation hardenable polyfunctional monomer or polyfunctional oligomer on a transparent support and subjecting the polyfunctional monomer or polyfunctional oligomer to a crosslinking reaction or polymerization reaction.

As the functional group of the ionizing radiation hardenable polyfunctional monomer or polyfunctional oligomer, photo, electron beam or ionizing radiation polymerizable functional groups are preferable. Above all, photopolymerizable functional groups are preferable.

Examples of the photopolymerizable functional group include unsaturated polymerizable functional groups such as a (meth)acryloyl group, a vinyl group, a styryl group, and an allyl group, with a (meth)acryloyl group being preferable.

Specific examples of the photopolymerizable polyfunctional monomer containing a photopolymerizable functional group include those as enumerated in the light scattering layer, and it is preferable that the polymerization is carried out by using a photopolymerization initiator and a photosensitizer. It is preferable that the photopolymerization reaction is carried out upon irradiation with ultraviolet rays after coating the hard coat layer and drying.

For the purpose of imparting brittleness to the hard coat layer, an oligomer and/or a polymer having a weight average molecular weight of 500 or more may be added.

Examples of the oligomer or polymer include (meth)acrylate based, cellulose based or styrene based polymers, urethane acrylates, and polyester acrylates. Above all, poly(glycidyl (meth)acrylate) and poly(allyl (meth)acrylate) each containing a functional group in the side chain thereof are preferable.

The content of the oligomer and/or polymer in the hard coat layer is preferably from 5 to 80% by weight, more preferably from 25 to 70% by weight, and especially preferably from 35 to 65% by weight based on the total weight of the hard coat layer.

The binder of the hard coat layer is added in an amount of from 30 to 95% by weight based on the solids content of the coating composition of the subject layer.

It is preferable that the hard coat layer containing an inorganic fine particle having an average particle size of a primary particle of not more than 200 nm. The “average particle size” as referred to herein is a weight average particle size. By regulating the average particle size of the primary particle at not more than 200 nm, a hard coat layer which does not impair the transparency can be formed.

The inorganic fine particle has functions to enhance the hardness of the hard coat layer and to inhibit hardening and shrinkage of the coating layer. Furthermore, the inorganic fine particle is also added for the purpose of controlling the refractive index of the hard coat layer.

Examples of the inorganic fine particle include, in addition to the inorganic fine particles as enumerated in the high refractive index layer, fine particles such as silicon dioxide, aluminum oxide, calcium carbonate, barium sulfate, talc, kaolin, calcium sulfate, titanium dioxide, zirconium oxide, tin oxide, ITO, and zinc oxide. Of these, silicon dioxide, titanium dioxide, zirconium oxide, aluminum oxide, tin oxide, ITO, and zinc oxide are preferable.

The average particle size of the primary particle of the inorganic fine particle is preferably from 5 to 200 nm, more preferably from 10 to 150 nm, further preferably from 20 to 100 nm, and especially preferably from 20 to 50 nm.

In the hard coat layer, it is preferable that the inorganic fine particle is dispersed finely as far as possible.

The inorganic fine particle in the hard coat layer preferably has a particle size of from 5 to 300 nm, more preferably from 10 to 200 nm, further preferably from 20 to 150 nm, and especially preferably from 20 to 80 nm in terms of an average particle size.

The content of the inorganic fine particle in the hard coat layer is preferably from 10 to 90% by weight, more preferably from 15 to 80% by weight, and especially preferably from 15 to 75% by weight based on the total weight of the hard coat layer.

The thickness of the hard coat layer can be appropriately desired depending upon the application. The thickness of the hard coat layer is preferably from 0.2 to 10 μm, more preferably from 0.5 to 7 μm, and especially preferably from 0.7 to 5 μm.

The hardness of the hard coat layer is preferably H or more, more preferably 2H or more, and most preferably 3H or more by a pencil hardness test according to the JIS K5400.

Furthermore, it is preferable that an abrasion amount of a specimen before and after the test by a taber test according to JIS K5400 is small as far as possible.

In forming the hard coat layer, in the case where the formation is carried out by a crosslinking reaction or polymerization reaction of an ionizing radiation hardenable compound, it is preferable that the crosslinking reaction or polymerization reaction is carried out in an atmosphere having an oxygen concentration of not more than 10% by volume. By carrying out the formation in an atmosphere having an oxygen concentration of not more than 10% by volume, a hard coat layer having excellent physical strength and chemical resistance can be formed.

The formation is more preferably carried out by a crosslinking reaction or polymerization reaction of an ionizing radiation hardenable compound in an atmosphere having an oxygen concentration of not more than 6% by volume, further preferably not more than 4% by volume, especially preferably not more than 2% by volume, and most preferably not more than 1% by volume.

As a measure for regulating the oxygen concentration at not more than 10% by volume, it is preferred to substitute the air (nitrogen concentration: about 79% by volume, oxygen concentration: about 21% by volume) with other gas. It is especially preferred to substitute (purge) the air with nitrogen.

It is preferable that the hard coat layer is formed by a method of properly diluting a coating composition for forming a hard coat layer with an organic solvent and coating it on a surface of a transparent support.

[Transparent Support]

As the transparent support of the optical film of the invention, it is preferred to use a plastic film. Examples of a polymer capable of forming a plastic film include cellulose acylates (for example, triacetyl cellulose, diacetyl cellulose, and representatively TAC-TD80U and TAC-TD80UF (all of which are manufactured by Fuji Film Corporation)), polyamides, polycarbonates, polyesters (for example, polyethylene terephthalate and polyethylene naphthalate), polystyrenes, polyolefins, norbornene based resins (for example, ARTON (a trade name, manufactured by JSR Corporation)), and amorphous polyolefins (for example, ZEONEX (a trade name, manufactured by Zeon Corporation). Of these, triacetyl cellulose, polyethylene terephthalate, and polyethylene naphthalate are preferable; and triacetyl cellulose is especially preferable.

The triacetyl cellulose is made of a single layer or plural layers. The triacetyl cellulose made of a single layer is prepared by drum casting or band casting or other means as disclosed in JP-A-7-11055; and the latter triacetyl cellulose film made of plural layers is prepared by a so-called co-casting method as disclosed in JP-A-61-94725 and JP-B-62-43846. That is, this method is a method in which in casting a solution (referred to as “dope”) prepared by dissolving a raw material flake in a solvent such as halogenated hydrocarbons (for example, dichloromethane), alcohols (for example, methanol, ethanol, and butanol), esters (for example, methyl formate and methyl acetate), and ethers (for example, dioxane, dioxolan, and diethyl ether) and optionally adding thereto a variety of additives such as a plasticizer, an ultraviolet ray absorber, an anti-deterioration agent, a slipping agent, and a peeling accelerator on a support composed of a horizontal endless metal belt or a rotatory drum by a dope feed measure (referred to as “die”), a single dope is subjected to single layer casting in the case of a single layer, or a low-concentration dope is subjected to co-casting on the both sides of a high-concentration cellulose ester dope in the case of plural layers; the dope is dried on the support to some extent, thereby separating a film to which rigidity has been imparted from the support; and the film is then passed through a drying section by a conveyance measure of every kind, thereby removing the solvent.

The triacetyl cellulose preferably has a refractive index of from 1.46 to 1.49, and more preferably from 1.47 to 1.48.

As the solvent for dissolving the foregoing triacetyl cellulose, dichloromethane is representative. However, from the viewpoint of the global environment or working environment, it is preferable that the solvent does not substantially contain a halogenated hydrocarbon such as dichloromethane. It is meant by the terms “does not substantially contain” that a proportion of the halogenated hydrocarbon in the organic solvent is less than 5% by weight (preferably less than 2% by weight).

In the case of preparing a dope of triacetyl cellulose using a solvent which does not substantially contain dichloromethane or the like, a special dissolution method as described later is essential.

In the case where the optical film of the invention is used in a liquid crystal display device, it can be arranged on the outermost surface of the display device by providing an adhesive layer on one surface thereof or other measure. Furthermore, the optical film of the invention may be combined with a polarizing plate. In the case where the subject transparent support is triacetyl cellulose, since the triacetyl cellulose is used as a protective film for protecting a polarizing film of the polarizing plate, it is preferred in view of costs to use the optical film of the invention as a protective film as it stands.

In the case where the optical film of the invention is arranged on the outermost surface of a display device by providing an adhesive layer on one surface thereof or other measure or is used as a protective film for polarizing plate as it is, for the purpose of sufficiently achieving bonding, it is preferred to carry out a saponification treatment after forming an outermost layer on the transparent support. The saponification treatment is carried out by a known measure, for example, dipping the subject film in an alkaline solution for a proper period of time. It is preferable that after dipping in the alkaline solution, the subject film is thoroughly washed with water or that the subject film is dipped in a dilute acid, thereby neutralizing an alkaline component such that the alkaline component does not remain in the subject film.

By the saponification treatment, the surface of the transparent support in the opposite side to the side having the outermost layer is hydrophilized.

The hydrophilized surface is especially effective for improving the adhesion properties to a polarizing film containing polyvinyl alcohol as the major component. Furthermore, in the hydrophilized surface, since dusts in air hardly attach thereto, the dusts hardly come into a space between the polarizing film and the optical film during bonding to the polarizing film. Thus, the hydrophilized surface is effective for preventing a point defect due to the dusts.

The saponification treatment is preferably carried out such that a contact angle of the surface of the transparent support in the opposite side having the outermost layer against water is preferably not more than 40°, more preferably not more than 30°, and especially preferably not more than 20°.

A concrete measure of the alkaline saponification treatment can be selected among the following two measures (1) and (2). The measure (1) is superior in view of the point that it can be carried out in the same step as in a general-purpose triacetyl cellulose film. However, since even the surface of the antireflection layer is also subjected to a saponification treatment, there may be caused problems that the surface is subjected to alkaline hydrolysis, thereby deteriorating the layer and that when a saponification treatment solution remains, it becomes a stain. In that case, the measure (2) is superior even when a special step is required.

(1) After forming each application layer on a transparent support, a back surface of the subject film is subjected to a saponification treatment by dipping in an alkaline solution at least one time.

(2) Before or after forming an application layer on a transparent support, an alkaline solution is coated on a surface in an opposite side to a surface of the subject optical film on which the optical layer is formed, heated, washed with water and/or neutralized, thereby subjecting only the back surface of the subject film to a saponification treatment.

[Coating System]

The optical film of the invention can be formed by the following method, but it should not be construed that the invention is limited thereto.

First of all, a coating solution containing components for forming each layer is prepared. Next, a coating solution for forming every functional layer is coated on a transparent support by a dip coating method, an air knife coating method, a curtain coating method, a roller coating method, a wire bar coating method, a gravure coating method, or a die coating method, followed by heating and drying. Above all, a microgravure coating method, a wire bar coating method and a die coating method (see U.S. Pat. No. 2,681,294 and JP-A-2006-122889) are more preferable, with a die coating method being especially preferable.

Thereafter, the monomer for forming a functional layer is polymerized and hardened upon irradiation with light or heating. In this way, the functional layer is formed. Here, if desired, the functional layer can be composed of plural layers.

Next, a coating solution for forming a low refractive index layer is similarly coated on the functional layer and irradiated with light or heated (irradiated with ionizing radiations such as ultraviolet rays, and preferably hardened upon irradiation with ionizing radiations under heating), thereby forming the low refractive index layer. There is thus obtained the optical film of the invention.

[Polarizing Plate]

A polarizing plate is configured mainly of two protective films for protecting both surfaces of a front side and a back side of a polarizing film. It is preferable that the optical film of the invention is used for at least one of the two protective films sandwiching a polarizing film from the both surfaces thereof. When the optical film of the invention also functions as a protective film, the manufacturing costs of the polarizing plate can be reduced. Furthermore, by using the optical film of the invention as an outermost surface layer, it is possible to form a polarizing plate which is prevented from reflection of external light or the like and which is excellent in scar resistance, antifouling properties, etc.

As the polarizing film, a known polarizing film can be used. Furthermore, a polarizing film which is cut out from a longitudinal polarizing film, an absorption axis of which is neither parallel nor vertical to the longitudinal direction, can also be used. A longitudinal polarizing film, an absorption axis of which is neither parallel nor vertical to the longitudinal direction, can be prepared by the following measure.

That is, such a longitudinal polarizing film is a polarizing film obtainable by stretching a continuously fed polymer film by imparting a tension while holding both ends thereof by a holding measure, which can be manufactured by a stretching method of stretching 1.1 to 20.0 times at least in a width direction of the film and bending in a state of holding the both ends of the film in an advancing direction of the film such that a difference in advancing rate in a longitudinal direction of a unit for holding the both ends of the film is within 3% and that an angle formed by the advancing direction of the film in an outlet of the step for holding the both ends of the film and a substantial stretching direction of the film is inclined at from 20 to 70°. In particular, a polarizing film in which the substantial stretching direction is inclined at 45° is preferably used from the viewpoint of productivity.

The stretching method of a polymer film is described in detail in paragraphs [0020] to [0030] of JP-A-2002-86554.

It is also preferable that of two protective films of a polarizer, a film other than the optical film is an optical compensating film containing an optically anisotropic layer. The optical compensating film (retardation film) is able to improve a viewing angle characteristic of a liquid crystal display screen.

Known optical compensating films can be used as the optical compensating film. An optical compensating film having an optical compensating layer made of a compound having a discotic structural unit and characterized in that an angle formed by the subject discotic compound and a support varies in a depth direction of the layer, as described in JP-A-2001-100042, is preferable from the standpoint of widening a viewing angle.

It is preferable that the subject angle increases with an increase of the distance of the optically anisotropic layer from the side of the support.

What a transparent support of at least one of two protective films of a polarizer is satisfactory with the following expressions (I) and (II) is preferable because an effect for improving display from an oblique direction of a liquid crystal display screen is high. In particular, it is especially preferable that the transparent support of the invention is satisfied with the following expressions (I) and (II).
0≦Re₍₆₃₀₎≦10 and |Rth₍₆₃₀₎|≦25 Expression (I)
|Re₍₄₀₀₎−Re₍₇₀₀₎|≦10 and |Rth₍₄₀₀₎−Rth₍₇₀₀₎|≦35 Expression (II)

In the expressions, Re represents an in-plane retardation (nm); Rth represents a retardation (nm) in a thickness direction; and numerical values in parentheses represent measurement wavelengths (nm).

[Image Display Device]

The optical film of the invention can be applied to image display devices such as a liquid crystal display device (LCD), a plasma display panel (PDP), an electroluminescence display device (ELD), a cathode ray tube display device (CRT), and a surface-conduction electron-emitter display (SED). In particular, the optical film of the invention is preferably used in a liquid crystal display device (LCD). Since the optical film of the invention has a transparent support, it is used by bonding the side of the transparent support to an image display face of an image display device.

In the case where the optical film of the invention is used as one side of a surface protective film of a polarizing film, it can be preferably used for transmission type, reflection type or semi-transmission type liquid crystal display devices of a twisted nematic (TN) mode, a super twisted nematic (STN) mode, a vertical alignment (VA) mode, an in-plane switching (IPS) mode, an optically compensatory bend cell (OCB) mode, or the like.

The liquid crystal cell of a VA mode includes, in addition to (1) a liquid crystal cell of a VA mode in a narrow sense in which a rod-like liquid crystalline molecule is substantially vertically aligned at the time of applying no voltage, whereas it is substantially horizontally aligned at the time of applying a voltage (as described in JP-A-2-176625), (2) a liquid crystal cell of a multi-domained VA mode (MVA mode) for enlarging a viewing angle (as described in SID 97, Digest of Tech. Papers, 28 (1997), page 845), (3) a liquid crystal cell of a mode (n-ASM mode) in which a rod-like liquid crystalline molecule is substantially vertically aligned at the time of applying no voltage and is subjected to twisted multi-domain alignment at the time of applying a voltage (as described in Preprints of Forum on Liquid Crystal, pages 58 to 59 (1998), and (4) a liquid crystal cell of a SURVIVAL mode (as announced in LCD International 98).

A liquid crystal cell of an OCB mode is a liquid crystal cell of a bend alignment mode in which a rod-like liquid crystalline molecule is aligned in a substantially reverse direction (in a symmetric manner) in the upper and lower parts of a liquid crystal cell and is disclosed in U.S. Pat. Nos. 4,583,825 and 5,410,422. Since the rod-like liquid crystalline molecule is symmetrically aligned in the upper and lower parts of a liquid crystal cell, the liquid crystal cell of a bend alignment mode has a self optical compensating ability. For that reason, this liquid crystal mode is also named as an OCB (optically compensatory bend) liquid crystal mode. A liquid crystal display device of a bend alignment mode involves an advantage that the response speed is fast.

In addition, what the whole including a liquid crystal cell of a bend alignment mode and an optically anisotropic layer has an optical characteristic which is satisfactory with the following expression (I′) in the measurement at any of wavelengths of 450 nm, 550 nm and 640 nm is preferable because an effect for improving display from an oblique direction of a liquid crystal display screen is high. In particular, it is especially preferable that a polarizing plate in which the optical film of the invention is used as a protective film is satisfactory with the following expression (I′).
0.05<(Δn×d)/(Re×Rth)<0.20 Expression (I′)

In the expression (I′), An represents an inherent birefringence of a rod-like liquid crystalline molecule in the liquid crystal cell; d represent a thickness (unit: nm) of the liquid crystal layer of the liquid crystal cell; Re represents an in-plane retardation value of the whole of the optical anisotropic layer; and Rth represents a retardation value in a thickness direction of the whole of the optical anisotropic layer.

In a liquid crystal cell of an ECB mode, a rod-like liquid crystalline molecule is substantially horizontally aligned at the time of applying no voltage, and the liquid crystal cell of an ECB mode is most frequently utilized as a color TFT liquid crystal display device and described in a number of documents. The liquid crystal cell of an ECB mode is described in, for example, EL, PDP and LCD Displays (published by Toray Research Center, Inc.) (2001).

In particular, with respect to liquid crystal display devices of a TN mode or an IPS mode, as described in JP-A-2001-100043, by using an optically compensatory film having an effect for enlarging a viewing angle for a surface in the opposite side to the optical film of the invention of two protective films on the back and front surfaces of the polarizing film, a polarizing plate having an antireflection effect and an effect for enlarging a viewing angle can be obtained in a thickness of a single polarizing plate, and therefore, such is especially preferable.

### EXAMPLES

The invention will be hereunder described with respect to the following Examples, but it should not be construed that the invention is limited thereto. All “part” and “%” are on a weight basis unless otherwise indicated.

(Preparation of Sol Solution a-1)

A 1,000-mL reactor equipped with a thermometer, a nitrogen introducing tube and a dropping funnel was charged with 187 g (0.80 moles) of acryloyloxypropyl trimethoxysilane, 29.0 g (0.21 moles) of methyl trimethoxysilane, 320 g (10 moles) of methanol and 0.06 g (0.001 moles) of KF, and 17.0 g (0.94 moles) of water was gradually added dropwise thereto with stirring at room temperature. After completion of the dropwise addition, the mixture was stirred for 3 hours and then heated and stirred for 2 hours under refluxing with methanol. Thereafter, a low boiling fraction was distilled off in vacuo, and the residue was further filtered to obtain 120 g of a sol solution a-1. The thus obtained substance was measured by GPC. As a result, the substance had a weight average molecular weight of 1,500, and among components including oligomer or polymer components, components having a molecular weight of from 1,000 to 20,000 accounted for 30% by weight.

Furthermore, it was revealed from a measurement result by 1H-NMR that the resulting substance had a structure represented by the following formula.

Average composition formula
(CH₂═COO—C₃H₆)_{0.8}(CH₃)_{0.2}SiO_{0.86}(OCH₃)_{1.28}

In addition, a condensation rate a by the ²⁹Si-NMR measurement was 0.59. It was understood from this analysis result that in the present silane coupling agent sol, a linear structure part accounted for the majority.

Furthermore, the gas chromatographic analysis revealed that a residual rate of the starting acryloyloxypropyl trimethoxysilane was not more than 5% by weight.

Composition of Coating Solution T for Antistatic Layer

| | |
|---|---|
| PELTRON C-4456-S7 | 100 g |
| Cyclohexanone | 30 g |
| MEK | 10 g |
| KBM-5103 | 1.5 g |

The foregoing coating solution was filtered through a polypropylene-made filter having a pore size of 10 μm, thereby preparing a coating solution for antistatic layer.

Composition of Coating Solution A-1 for Light Scattering Layer

| | |
|---|---|
| PET-30 | 45.6 g |
| IRGACURE 184 | 2.0 g |
| 8-μm crosslinked acrylic particle (30%) | 14.5 g |
| SX-350H (30%) | 14.5 g |
| FP-149 | 0.75 g |
| Sol solution a-1 | 10.0 g |
| Toluene | 28.5 g |

Composition of Coating Solution A-2 for Light Scattering Layer

| | |
|---|---|
| PET-30 | 45.6 g |
| IRGACURE 184 | 2.0 g |
| 8-μm crosslinked acrylic particle (30%) | 14.5 g |
| KEP-150 (30%) | 14.5 g |
| FP-149 | 0.75 g |
| Sol solution a-1 | 10.0 g |
| Toluene | 28.5 g |

Composition of Coating Solution A-3 for Light Scattering Layer

| | |
|---|---|
| PET-30 | 44.0 g |
| IRGACURE 184 | 2.0 g |
| 8-μm crosslinked acrylic particle (30%) | 14.5 g |
| KEP-150 (30%) | 20.0 g |
| FP-149 | 0.75 g |
| Sol solution a-1 | 10.0 g |
| Toluene | 24.7 g |

Composition of Coating Solution A-4 for Light Scattering Layer

| | |
|---|---|
| PET-30 | 47.9 g |
| IRGACURE 184 | 2.0 g |
| MX-1500H (30%) | 7.0 g |
| KEP-150 (30%) | 14.5 g |
| FP-149 | 0.75 g |
| Sol solution a-1 | 10.0 g |
| Toluene | 33.8 g |

Composition of Coating Solution R-1 for Light Scattering Layer

| | |
|---|---|
| PET-30 | 50.0 g |
| IRGACURE 184 | 2.0 g |
| 8-μm crosslinked acrylic particle (30%) | 14.5 g |
| FP-149 | 0.75 g |
| Sol solution a-1 | 10.0 g |
| Toluene | 28.5 g |

Composition of Coating Solution R-2 for Light Scattering Layer

| | |
|---|---|
| PET-30 | 28.0 g |
| IRGACURE 184 | 1.4 g |
| MX-150 (40%) | 55.0 g |
| 8-μm crosslinked acrylic particle (30%) | 14.5 g |
| FP-149 | 0.75 g |
| Sol solution a-1 | 10.0 g |
| Toluene | 5.5 g |

Composition of Coating Solution R-3 for Light Scattering Layer

| | |
|---|---|
| PET-30 | 50.0 g |
| IRGACURE 184 | 2.0 g |
| SX-350H (30%) | 14.5 g |
| Sol solution a-1 | 10.0 g |
| Toluene | 38.5 g |

Each of the foregoing coating solutions for light scattering layer was filtered through a polypropylene-made filter having a pore size of 10 μm, thereby preparing a coating solution.

In the foregoing coating solutions, a refractive index of the matrix was 1.51.

A reactive index of each of the particles was as follows.

| | |
|---|---|
| 8-μm crosslinked acrylic particle | 1.49 |
| SX-350H (30%) | 1.60 |
| KEP-150 (30%) | 1.45 |
| MX-150 (40%) | 1.49 |
| MX-1500H (40%) | 1.49 |

Composition of Coating Solution C-1 for Low Refractive Index Layer

| | |
|---|---|
| JTA-113 | 63.7 g |
| MEK-ST-L | 6.4 g |
| Sol solution a-1 | 2.9 g |
| Methyl ethyl ketone | 24.5 g |
| Cyclohexanone | 2.9 g |

The foregoing coating solution was filtered through a polypropylene-made filter having a pore size of 1 μm, thereby preparing a coating solution C-1 for low refractive index layer. A layer formed by this coating solution had a refractive index of 1.45.

The respective compounds as used are as follows.
PELTRON C-4456-S7: ATO-dispersed hard coating agent (solids concentration: 45%, manufactured by Nippon Pelnox Corp.)
KBM-5103: Silane coupling agent (acryloyloxypropyl trimethoxysilane) (manufactured by Shin-Etsu Chemical Co., Ltd.)
PET-30: Mixture of pentaerythritol triacrylate and pentaerythritol tetraacrylate (manufactured by Nippon Kayaku Co., Ltd.)
MX-150: 40% solution of crosslinked acrylic particle (average particle size: 1.5 μm, manufactured by Soken Chemical & Engineering Co., Ltd.) dispersed in toluene
MX-1500H: 30% solution of crosslinked acrylic particle (average particle size: 15 μm, manufactured by Soken Chemical & Engineering Co., Ltd.) dispersed in toluene
IRGACURE 184: Polymerization initiator (manufactured by Ciba Speciality Chemicals)
MEK-ST-L: Colloidal silica sol dispersion (having a different silica particle size from MEK-ST and having an average particle size of 45 nm and a solids concentration of 30% by weight, manufactured by Nissan Chemical Industries, Ltd.)
JTA113: Thermally hardenable fluorine-containing polymer containing polysiloxane and a hydroxyl group having a refractive index of 1.44 (solids concentration: 6%, manufactured by JSR Corporation)
SX-350H: Crosslinked polystyrene particle having an average particle size of 3.5 μm [(refractive index: 1.60) as a 30% toluene dispersion, manufactured by Soken Chemical & Engineering Co., Ltd.; as used after dispersing by a Polytron dispersing machine at 10,000 rpm for 20 minutes]
KEP-150: Silica particle having an average particle size of 1.5 μm [(refractive index: 1.45) as a 30% toluene dispersion, manufactured by Nippon Shokubai Co., Ltd.; as used after dispersing by a Polytron dispersing machine at 10,000 rpm for 20 minutes]
FP-149: Fluorine based surfactant as described in this specification

### Example 1

Preparation of Optical Film Samples 101 to 133:

(1) Application of Antistatic Layer:

An 80 μm-thick triacetyl cellulose film (TAC-TD80U, manufactured by Fuji Film Corporation) was wound out in a rolled state; the coating solution for antistatic layer was coated and dried at 60° C. for 150 seconds; and thereafter, the coating layer was further irradiated with ultraviolet rays having a radiation illuminance of 400 mW/cm² and an irradiation dose of 250 mJ/cm² by using an air-cooled metal halide lamp (manufactured by Eyegraphics Co., Ltd.) of 160 W/cm under purging with nitrogen, thereby forming an antistatic layer having a thickness of 1.3 μm.

(2) Application of Light Scattering Layer:

Each of the coating solutions for light scattering layer as shown in Table 1 was coated on the antistatic layer with respect to a sample having the foregoing antistatic layer applied thereon, or directly on an 80 μm-thick triacetyl cellulose film (TAC-TD80U, manufactured by Fuji Film Corporation) having been wound out in a rolled state with respect to a sample not having an antistatic layer, under a conveyance rate of 30 cm/min in a die coating method using the slot die disclosed in Example 1 of JP-A-2006-122889; and after drying at 60° C. for 150 seconds, the coating layer was hardened upon irradiation with ultraviolet rays having a radiation illuminance of 400 mW/cm² and an irradiation dose of 250 mJ/cm² by using an air-cooled metal halide lamp (manufactured by Eyegraphics Co., Ltd.) of 160 W/cm under purging with nitrogen, thereby forming a light scattering layers, followed by winding up.

(3) Application of Low Refractive Index Layer:

The triacetyl cellulose film having the subject antistatic layer and light scattering layer applied thereon was again wound out; the foregoing coating solution for low refractive index layer was coated under a conveyance rate of 30 cm/min in a die coating method using the foregoing slot die and dried at 120° C. for 75 seconds; and after further drying for 10 minutes, the coating layer was irradiated with ultraviolet rays having a radiation illuminance of 400 mW/cm² and an irradiation dose of 240 mJ/cm² by using an air-cooled metal halide lamp (manufactured by Eyegraphics Co., Ltd.) of 240 W/cm under purging with nitrogen, thereby forming a low refractive index layer having a thickness of 100 nm, followed by winding up.

(Preparation of Optical Film Sample)

Optical film samples were prepared in a combination of layers as shown in the following Table 1 by the foregoing methods. The application layers were stacked on the support and coated successively in the order from the left side as shown in Table 1.

TABLE 1

| | | Antistatic | | Light | | Low | |
|---|---|---|---|---|---|---|---|
| | | layer | | scattering layer | | refractive index | |
| | | Coating | Thickness | Coating | Thickness | Coating | Thickness |
| Sample No. | Remark | solution | (μm) | solution | (μm) | solution | (μm) |
| 101 | Invention | Nil | — | A-1 | 13 | Nil | — |
| 102 | Invention | Nil | — | A-2 | 13 | Nil | — |
| 103 | Invention | T | 1.3 | A-2 | 13 | Nil | — |
| 111 | Invention | Nil | — | A-1 | 13 | C-1 | 0.1 |
| 112 | Invention | Nil | — | A-2 | 13 | C-1 | 0.1 |
| 113 | Invention | T | 1.3 | A-2 | 13 | C-1 | 0.1 |
| 114 | Invention | Nil | — | A-3 | 13 | C-1 | 0.1 |
| 115 | Invention | Nil | — | A-4 | 30 | C-1 | 0.1 |
| 121 | Comparison | Nil | — | R-1 | 13 | Nil | — |
| 122 | Comparison | Nil | — | R-2 | 13 | Nil | — |
| 123 | Comparison | Nil | — | R-3 | 13 | Nil | — |
| 131 | Comparison | Nil | — | R-1 | 13 | C-1 | 0.1 |
| 132 | Comparison | Nil | — | R-2 | 13 | C-1 | 0.1 |
| 133 | Comparison | Nil | — | R-3 | 13 | C-1 | 0.1 |

(Saponification Treatment of Optical Film)

After the application, each of the foregoing samples was subjected to the following treatment. A sodium hydroxide aqueous solution of 1.5 moles/L was prepared and kept at a temperature of 55° C. A dilute sulfuric acid aqueous solution of 0.01 moles/L was prepared and kept at a temperature of 35° C. The prepared optical film was dipped in the foregoing sodium hydroxide aqueous solution for 2 minutes and then dipped in water, thereby thoroughly washing away the sodium hydroxide aqueous solution. Next, after dipping in the foregoing dilute sulfuric acid aqueous solution for one minute, the optical film was dipped in water, thereby thoroughly washing away the dilute sulfuric acid aqueous solution. Finally, the sample was thoroughly dried at 120° C.

There were thus prepared saponification treated optical films (Samples 101 to 115 of the invention and Samples 121 to 133 of the comparison).

(Preparation of Polarizing Plate)

Both surfaces of a polarizing film which had been prepared by adsorbing iodine onto polyvinyl alcohol and stretched were adhered to and protected by each film of an 80 μm-thick triacetyl cellulose film (TAC-TD80U, manufactured by Fuji Film Corporation) which had been dipped in an NaOH aqueous solution of 1.5 moles/L at 55° C. for 2 minutes, neutralized and then washed with water and each of the samples (saponification treated) of the invention in Example 1, thereby preparing a polarizing plate. There were thus prepared polarizing plates.

(Evaluation of Optical Film and Polarizing Plate)

The obtained optical film samples were evaluated with respect to the following items. The results obtained are shown in Table 2.

(1) Haze:

(1) The total haze value (H) of the obtained optical film is measured according to JIS K7136;
(2) Onto the front face and the rear face of the optical film, several drops of silicone oil are added dropwise. Then, the film is sandwiched from the opposite sides by the use of two glass sheets with a thickness of 1 mm {“Micro slide glass product No. S9111”, manufactured by MATSUNAMI Glass IND Ltd.}. Thus, a complete optical adhesion between the two glass sheets and the optical film is established. The haze is measured with the surface haze removed. Then, a value obtained by subtracting the value separately measured with only silicone oil sandwiched between two glass sheets therefrom is calculated as the internal haze(Hi) of the film; and
(3) A value obtained by subtracting the internal haze (Hi) calculated in the item (2) from the total haze (H) measured in the item (1) is calculated as the surface haze (Hs) of the film.
   (2) Average Reflectance:

A back surface of the film was roughed with a sheet of sandpaper and then treated a black ink, thereby making it free from reflection of the back surface. In this state, a spectral reflectance of the surface side was measured in a wavelength region of from 380 to 780 nm by using a spectrophotometer (manufactured by JASCO Corporation). An arithmetic average value of an integrated reflectance at from 450 to 650 nm was employed as the result.

(3) Firmness of Black Color:

With respect to a liquid crystal display device arranged with a polarizing plate having an optical film stacked on a surface in a viewing side thereof, firmness of black color was organoleptically evaluated. The evaluation was carried out in a method such that several displays were arranged in parallel and relatively compared at the same time; and that the respective film were compared for a black taste at the time of turning off a power source and a black taste (black image) at the time of turning on a power source from a direct frontal position and evaluated according to the following criteria. The results were expressed on a standard that the stronger the black taste, the stronger the firmness of screen.

A: The black taste is strong, and the screen is seen very strongly firmly.

B: The black taste is strong, and the screen is seen strongly firmly.

C: The color is black but grayish, and the firmness of the screen is weak.

D: The grayish color is considerably strong, and the firmness of the screen is not found.

(4) Antiglare Properties:

A black marker ink was entirely painted over a back side of the application surface of the resulting film; and in the case of reflecting a bare fluorescent lamp (8,000 cd/m²) without a louver from an angle of 5° and observing from a direction of −5° and in the case of reflecting it from an angle of 45° and observing from a direction of −45°, a degree of fuzziness of the reflected image was evaluated according to the following criteria.

A: A degree such that the outline of the fluorescent lamp is slightly observed at both −5° and at −45°.

B: A degree such that the outline of the fluorescent lamp is slightly observed at −5°, whereas the outline is comparatively distinctly noted at −45°.

C: The outline of the fluorescent lamp is comparatively distinctly noted at both −5° and at −45°.

D: The outline of the fluorescent lamp is distinctly noted and is glaring at both −5° and at −45°.

(5) Evaluation of Pencil Hardness:

As an index of the scar resistance, pencil hardness was evaluated according to JIS K-5400. After humidity control at temperature of 25° C. and at a humidity of 60% RH for 2 hours, the optical film was evaluated under a load of 1 kg according to the following criteria by using pencils for test of 3H as defined in JIS S-6006.

A: A scar is not found at all in the evaluation of n=5.

B: One or two scars are found in the evaluation of n=5.

C: Three or more scars are found in the evaluation of n=5.

(6) Evaluation of Contrast in Mounting:

The prepared polarizing plate was stuck in place of a polarizing plate in a viewing side of a liquid crystal television set (“LC-37GD4” (MVA mode), manufactured by Sharp Corporation). A screen image was shown in a dark room, and the contrast was visually evaluated from the front and in an obliquely upper direction of 45° at a polar angle of 60°.

(Frontal Contrast)

A: A lowering of the contrast is not conscious at all.

B: A lowering of the contrast is not substantially conscious.

C: A lowering of the contrast is conscious.

(Contrast in Obliquely Upper Direction)

A: The contrast and color taste are significantly improved as compared with the case of sticking only a tuck (TAC-TD80U).

B: The contrast and color taste are improved as compared with the case of sticking only a tuck (TAC-TD80U).

C: The contrast and color taste are not substantially improved as compared with the case of sticking only a tuck.

TABLE 2

| | | | | | | | | | Contrast in |
|---|---|---|---|---|---|---|---|---|---|
| | | | | Average | Firmness | | | | obliquely |
| | | Surface haze | Internal haze | Reflectance | of black | Antiglare | Pencil | Frontal | upper |
| Sample No. | | (%) | (%) | (%) | color | properties | hardness | contrast | direction |
| 101 | Invention | 7 | 30 | 4.3 | B | A | A | A | B |
| 102 | Invention | 2 | 53 | 4.3 | B | A | A | A | B |
| 103 | Invention | 2 | 53 | 4.3 | B | A | A | A | B |
| 111 | Invention | 6 | 30 | 2.7 | A | A | A | A | B |
| 112 | Invention | 2 | 53 | 2.7 | A | A | A | A | B |
| 113 | Invention | 2 | 53 | 2.7 | A | A | A | A | B |
| 114 | Invention | 3 | 70 | 2.7 | A | A | A | A | A |
| 115 | Invention | 3 | 89 | 2.7 | A | A | A | B | A |
| 121 | Comparison | 2 | 4 | 4.3 | B | A | A | A | C |
| 122 | Comparison | 4 | 9 | 4.3 | B | A | A | A | C |
| 123 | Comparison | 0 | 32 | 4.3 | C | D | A | A | B |
| 131 | Comparison | 2 | 4 | 2.7 | A | A | A | A | C |
| 132 | Comparison | 3 | 9 | 2.7 | A | A | A | A | C |
| 133 | Comparison | 0 | 32 | 2.7 | C | D | A | A | B |

The following are clear from the results as shown in Table 2.

In the optical film of the invention, the optical performance (for example, average reflectance, firmness of black color, and antiglare properties) falls within a desired range as an antireflection film, the hardness of the coating film is high, and the scar resistance by a pencil, etc. is excellent. In addition, the film having a low refractive index layer stacked on a light scattering layer is excellent in the average reflectance and firmness of black color and is also excellent in resistance to fingerprint attachment. The film in which the antistatic layer is placed in a lower side of the light scattering layer was also excellent in resistance to dust attachment. In addition, when the film of the invention was mounted in a liquid crystal display device, a lowering of the frontal contrast was small, and the contrast in an oblique direction was improved.

These optical films having excellent comprehensive performance as an antireflection film were first clarified by the invention.

### Example 2

An optical film was prepared in the same production method as in Sample No. 101, except for changing the thickness of Sample No. 101 to 6 μm. As a result, the surface haze was 15%, the firmness of black color was worse, and the white taste was strong. Also, the pencil hardness was lowered to “B”. An optical film was prepared in the same production method as in Sample No. 101, except for changing the thickness of Sample No. 101 to 35 μm. As a result, the antiglare properties became worse as “D”. Also, the curl became large.

### Example 3

(Preparation of Coating Solution C-2 for Low Refractive Index Layer)

(Preparation of Dispersion A)

To 500 g of a hollow silica fine particle sol (a silica sol in isopropyl alcohol, average particle size: 60 nm, shell thickness: 10 nm, silica concentration: 20% by weight, refractive index of silica particle: 1.31; as prepared by changing the size in conformity to Preparation Example 4 of JP-A-2002-79616), 30 g of acryloyloxypropyl trimethoxysilane (manufactured by Shin-Etsu Chemical Co., Ltd.) and 1.5 g of diisopropoxyaluminum ethyl acetate were added and mixed. After adding 9 g of ion exchanged water, the mixture was reacted at 60° C. for 8 hours. After cooling to room temperature, 1.8 g of acetyl acetone was added. Solvent substitution was carried out by distillation in vacuo under a pressure of 20 kPa while adding cyclohexanone to 500 g of this dispersion such that the content of silica became substantially constant. The dispersion was free from the generation of a foreign substance. When the solids concentration was adjusted with cyclohexanone at 20% by weight, the viscosity was found to be 5 mPa·s at 25° C. The residual amount of isopropyl alcohol in the obtained dispersion A was analyzed by gas chromatography. As a result, it was found to be 1.5%.

(Preparation of Coating Solution C-2)

To 783.3 parts by parts (47.0 parts by weight as a solids content) of OPSTAR JTA113 (heat crosslinking fluorine-containing silicone polymer composition solution (solids content: 6%), manufactured by JSR Corporation), 195 parts (39.0 parts by weight as a solids content of the total sum of silica and surface treating agent) of the dispersion A, 30.0 parts by weight (9.0 parts by weight as a solids content) of a colloidal silica dispersion (silica having a different particle size from MEK-ST, average particle size: 45 nm, solids content: 30%, manufactured by Nissan Chemical Industries, Ltd.), and 17.2 parts by weight (5.0 parts by weight as a solids content) of the sol solution a-1. The mixture was diluted with cyclohexane and methyl ethyl ketone such that the solids content of the entire coating solution was 6% by weight and that a ratio of cyclohexane to methyl ethyl ketone was 10/90, thereby preparing a coating solution C-2 for low refractive index layer. A layer formed from this coating solution had a refractive index of 1.39.

An optical film was prepared in the same production method as in Sample No. 111, except for changing the coating solution for low refractive index layer of Sample No. 111 to C-1. As a result, the reflectance was lowered to 1.7%; the firmness of black color was improved; the reflection of a fluorescent lamp reflected onto the surface at the time of evaluation of antiglare properties became small; and the antireflection performance was improved.

### Example 4

Both surfaces of a polarizing film which had been prepared by adsorbing iodine onto polyvinyl alcohol and stretched were adhered to and protected by each film of an 80 μm-thick triacetyl cellulose film (TAC-TD80U, manufactured by Fuji Film Corporation) which had been dipped in an NaOH aqueous solution of 1.5 moles/L at 55° C. for 2 minutes, neutralized and then washed with water and the sample (saponification treated) of the invention in Example 1, thereby preparing a polarizing plate. The thus prepared polarizing plate was substituted for a polarizing plate in a viewing side of a liquid crystal display device of a notebook personal computer mounted with a transmission TN liquid crystal display device (having D-BEF, manufactured by Sumitomo 3M Limited as a polarizing separation film having a polarizing selective layer between a backlight and a liquid crystal cell) such that the light scattering layer or the low refractive index layer was an outermost surface. As a result, the reflection of the background was extremely small, and a display device having a very high display grade was obtained.

### Example 5

An optical compensating film (WIDE VIEW FILM ACE, manufactured by Fuji Film Corporation) was used as a protective film in the liquid crystal cell side of the polarizing plate in the viewing side of the transmission TN liquid crystal cell having each of the films of the samples of the invention stuck thereonto in Example 1 and a protective film in the liquid crystal cell side of the polarizing plate in the backlight side. As a result, there was obtained a liquid crystal display device which is excellent in contrast in a bright room, very wide in a viewing angle up and down, left and right, extremely excellent in visibility and high in display grade.

Furthermore, Sample Nos. 101 to 115 of the invention had a scattered light intensity at 30° against an outgoing angle of 0° of 0.06% or more. Because of this light diffusibility, there was obtained a very satisfactory liquid crystal display device in which a viewing angle especially in the downward direction was increased and a yellow taste in the left and right direction was improved.

### Example 6

An 80 μm-thick cellulose acylate sample (No. 201) was prepared by a co-casting method by using cellulose acylate having a degree of acetyl substitution in a proportion of 49.3% (against cellulose acylate) of an optical anisotropy-lowering agent A-19 and 7.6% (against cellulose acylate) of a wavelength dispersion adjusting agent UV-102. The resulting film had sufficiently small retardation values such that a retardation (Re) was −1.0 nm (as defined to be negative because of a slow axis in the TD direction) and that a retardation (Rth) in a thickness direction was −2.0 nm. This cellulose acylate film sample was used for a transparent support of a protective film in a cell side of two protective films of a polarizer, and each of the films of the samples of the invention in Example 1 was used as a protective film in a viewing side of the polarizer. The resulting film was evaluated in a liquid crystal display device as described in Example 1 of JP-A-10-48420, an optically anisotropic layer containing a discotic liquid crystal molecule as described in Example 1 of JP-A-9-26572, an alignment film having polyvinyl alcohol coated thereon, a VA type liquid crystal device as described in FIGS. 2to 9 of JP-A-2000-154261, and an OCB type liquid crystal display device as described in FIGS. 10to 15 of JP-A-2000-154261, respectively. In all of the cases, a performance with a good contrast viewing angle was obtained.

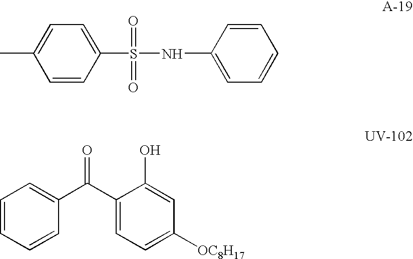

### Example 7

Each of the films of the samples of the invention in Example 1 was stuck on a glass plate of a surface of an organic EL display device via an adhesive. As a result, the reflection on the glass surface was suppressed, thereby obtaining a display device with high visibility.

### Example 8

By using each of the films of the samples of the invention in Example 1, a polarizing plate having the optical film of the invention on one surface thereof was prepared. Then, a λ/4 plate was stuck on an opposite surface to the side of the optical film of the invention of the polarizing plate and stuck onto a glass plate on a surface of an organic EL display device such that the side of the optical film of the invention was an outermost surface. As a result, the surface reflection and the reflection from the inside of the surface glass were cut, thereby obtaining a display with extremely high visibility.

This application is based on Japanese Patent application JP 2005-362054, filed Dec. 15, 2005, the entire content of which is hereby incorporated by reference, the same as if set forth at length.

What is claimed is:

1. An optical film comprising a transparent support and a light scattering layer, wherein
the light scattering layer contains at least two translucent particles including translucent particles A and B in a matrix of the light scattering layer, the translucent particle A has an average particle size of larger than 5 μm and not more than 15 μm, and the translucent particle B has an average particle size of 0.5 μm or more and not more than 5 μm, in which a difference between a refractive index of the translucent particle B and a refractive index of the matrix is 0.04 or more, and
the light scattering layer has a thickness of from 8 to 30 μm.

2. The optical film according to claim 1, wherein a haze value as caused due to surface scattering is not more than 10%.

3. The optical film according to claim 1, wherein a haze value as caused due to internal scattering is from 10 to 90%.

4. The optical film according to claim 1, wherein a haze value as caused due to internal scattering caused by the particle B is from 10 to 90%.

5. The optical film according to claims 1, wherein a difference between a refractive index of the particle A and a refractive index of the matrix is smaller than the difference between a refractive index of the particle B and a refractive index of the matrix.

6. The optical film according to claim 1, wherein a difference between a refractive index of the particle A and a refractive index of the matrix is 0.05 or less.

7. The optical film according to claim 1, further comprising a layer having a lower refractive index than the refractive index of the matrix, so that the transparent support, the light scattering layer and the layer having a lower refractive index are provided in this order.

8. The optical film according to claim 7, wherein the layer having a lower refractive index has a refractive index of from 1.20 to 1.48.

9. The optical film according to claim 7, wherein the layer having a lower refractive index has a refractive index of from 1.30 to 1.46.

10. The optical film according to claim 1, wherein an integrated reflectance is not more than 3.5%.

11. The optical film according to claim 1, wherein the translucent particle A has an average particle size of from 6 to 13 μm.

12. The optical film according to claim 1, wherein the translucent particle A has an average particle size of from 7 to 10 μm.

13. The optical film according to claim 1, wherein the translucent particle B has an average particle size of from 1 to 4 μm.

14. A polarizing plate comprising two protective films and a polarizing film provided between the protective films, wherein at least one of the protective films is the optical film according to claim 1.

15. An image display device comprising the optical film according to claim 1.

16. A liquid crystal display device comprising the optical film according to claim 1.
